(19) United States
(12) Patent Application Publication
(10) Pub. No.: US 2002/0122922 A1
(43) Pub. Date: Sep. 5, 2002

(54) Method for preparing image-recorded material

(76) Inventors: Makoto Yamada, Kanagawa (JP); Yoshiharu Yabuki, Kanagawa (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/026,974

(22) Filed: Dec. 27, 2001

(30) Foreign Application Priority Data
Dec. 27, 2000 (JP) P. 2000-398060
Sep. 7, 2001 (JP) P. 2001-271991

(51) Int. Cl. B41M 5/00; B41M 3/12

(52) U.S. Cl. 428/204; 427/152

(57) ABSTRACT

A method comprising: recording an image on a material by an ink jet recording system using water-based ink comprising a colorant; transferring a layer comprising a radiation-curing compound that is capable of being a resin at curing from a protective layer-imparting material comprising a support and the layer, the layer being capable of being released from the protective layer-imparting material, to a surface of the material; and curing the layer by irradiation of a radiation to form a protective layer.

### FIELD OF THE INVENTION

The present invention relates to a method for preparing an image-recorded material by an ink jet recording process, which provides a high quality recorded image, excellent discharge stability and an image excellent in weather resistance; and an image-recorded material obtained thereby.

### BACKGROUND OF THE INVENTION

With the recent spread of computers, ink-jet printers have been widely utilized for printing paper, film, cloth and the like, not only in offices, but also in homes. As ink-jet recording ink, there are known water-based ink, oil-based ink and solid ink. However, the water-based ink is mainly used in terms of production, handling, odors and safety.

In many cases, however, the water-based ink has the advantages of high transparency and color density, but the disadvantage of poor water resistance, which causes blurring (bleeding) on printing on so-called plain paper, resulting in significantly deteriorated printing quality, because water-soluble dyes soluble in the molecular state are used. Further, the water-based ink also has the disadvantage of very poor light resistance. Further, in recent years, it has also been known that the water-based ink is influenced by gases such as ozone in respect to weather resistance.

For overcoming the above-mentioned disadvantages, water-based ink using pigments or disperse dyes has variously been reported, for example, in JP-A-56-157468 (the term “JP-A” as used herein means an “unexamined published Japanese patent application”), JP-A-4-18468, JP-A-10-110126 and JP-A-10-195355. These methods improve the water resistance, but are insufficient. In particular, pigment ink has the problems that it is inferior to dye ink in color development, that bronze is liable to develop on a surface of paper, and that the use of glossy paper for photographic quality is apt to make a difference in a gloss between a printed area and a non-printed area.

Further, JP-A-58-45272 proposes a method of involving a dye in urethane polymer latex particles. However, this method has the disadvantage that it is difficult to obtain colored particles excellent in dispersion stability when the dye is involved in a desired concentration. Furthermore, JP-A-10-279873 discloses a method of preparing fine colored polymer particles by dissolving an acrylic polymer and an oil-soluble dye in an organic solvent, and removing the organic solvent after dispersing. However, this method has raised problems with regard to the quality of recorded images, particularly the quality of images recorded on paper media for photographic quality, and stability in continuous recording.

Further, the oil-soluble dyes disclosed are insufficient in color reproduction based on insufficient color hues, and the storage stability of images obtained is also insufficient.

For improving the storage stability, JP-A-1-170674 discloses ink jet recording solutions containing UV absorbers and/or antioxidants. However, they can not be said to be sufficient in respect to light resistance, and further improvement in image keeping quality has been desired.

Methods of laminating transparent films on image faces have been used for improving image keeping quality. However, these methods are difficult to use thin films in terms of operations of lamination, which has raised the problem of increasing the thickness of images obtained.

Instead of the laminating methods, there are also methods of coating image surfaces with thermosetting resin coatings or radiation-curing resin coatings and curing them. However, these methods have the problems that solvents contained in coatings are liable to attack images to cause color degradation and changes in color, that blurring of images is enhanced, that it is difficult to form uniform coating films, that coating solutions are contaminated with dust during their storage, and that dust adheres in coating. Moreover, these methods require a troublesome operation called a coating step.

### SUMMARY OF THE INVENTION

An object of the invention is to provide a method for forming an image-recorded material which is good in terms of water resistance, light resistance and weather resistance although using water-based ink excellent in handling, odors and safety, and can give an image having no difference in a gloss between a printed area and a non-printed area, that is to say, no gloss unevenness, and developing little bronze.

It is another object of the invention to provide an image-recorded material obtained by the above-mentioned method.

According to the invention, there are provided:

(1) A method comprising the steps of:

(a) recording an image on a material by an ink jet recording system using water-based ink comprising a colorant;

(b) laying a protective layer-imparting material comprising a support and a layer comprising a radiation-curing compound that is capable of being a resin at curing, the layer being capable of being released from the protective layer-imparting material, on a surface of the material in such a way that the surface of the material and the layer face each other;

(c) laminating the surface of the material and the protective layer-imparting material by at least one of heating and the application of pressure;

(d) curing the layer by irradiation of a radiation to form a protective layer; and

(e) releasing the support from the protective layer-imparting material.

(2) The method as described in (1) above, wherein the method is carried out by one of three processes of:

1) step (a), step (b), step (c), step (d) and step (e), in order;

2) step (a), step (b), step (c), step (e) and step (d), in order; and

3) step (a), step (b), step (c), step (d), step (e) and step (d), in order.

(3) The method as described in (1) or (2), which further comprising drying process after recording an image on a material by an ink jet recording system using water-based ink comprising a colorant.

(4) The method as described in any one of (1) to (3) above, wherein the colorant is a water-soluble dye.

(5) The method as described in any one of (1) to (3) above, wherein the colorant is an oil-soluble dye.

(6) The method as described in (5) above, wherein the water-based ink further comprises a high boiling organic solvent.

(7) The method as described in any one of (1) to (3) above, wherein the colorant is a pigment.

(8) The method as described in (6) above, wherein the oil-soluble dye and the high boiling organic solvent are dispersed in the water-based ink in an average particle size of 1 μm or less.

(9) The method as described in (7) above, wherein the pigment is dispersed in the water-based ink in an average particle size of 1 μm or less.

(10) The method as described in any one of (1) to (9) above, wherein the water-based ink further comprises a water-soluble organic solvent.

(11) The method as described in any one of (1) to (10) above, wherein the material comprises a support and an image receiving layer comprising a white inorganic pigment particle.

(12) The method as described in any one of (1) to (11) above, wherein the protective layer has a thickness of from 0.1 μm to 50 μm when the protective layer is dry.

(13) An image-recorded material comprising a protective layer prepared by the method as described in any one of (1) to (12) above.

### DETAILED DESCRIPTION OF THE INVENTION

The invention will be described in detail below.

In the method for forming the image-recorded material of the invention, a protective layer-imparting material is used in which a layer containing at least one radiation-curing compound curable to a resin is releasably provided on a support.

The layer is transferred from the above-mentioned protective layer-imparting material to a surface of an image-recorded material on which an image (defined as image and/or literal information) is recorded by an ink jet recording system using water-based ink containing at least one colorant. The transferred layer functions as a protective layer for protecting the surface of the image-recorded material.

Further, the method for preparing the image-recorded material will be described in detail.

The method comprises laying the protective layer-imparting material on the surface of the image-recorded material on which an image is recorded by an ink jet recording system using water-based ink containing at least one colorant, the protective layer-imparting material comprising the support and the layer releasably provided thereon which contains at least one radiation-curing compound curable to a resin, in such a way that the surface of the image and the layer face each other, and at least one of the following two steps of:

(1) laminating them by heating and/or the application of pressure, curing the layer by irradiation of a radiation, and then, separating the support to form a protective layer, and

(2) laminating them by heating and/or the application of pressure, transferring the layer onto the surface of the image, separating the support, and irradiating the layer with a radiation to form a protective layer.

That is to say, the method for forming the image-recorded material of the invention includes methods in which the above-mentioned two steps are each independently executed, and the combination thereof.

The combination of the above-mentioned two steps is a method comprising laying the protective layer-imparting material on the surface of the image-recorded material on which an image is recorded by an ink jet recording system using water-based ink containing at least one colorant, the protective layer-imparting material comprising the support and the layer releasably provided thereon which contains at least one radiation-curing compound curable to a resin, in such a way that the surface of the image and the layer face each other, laminating them by heating and/or the application of pressure, curing the layer by irradiation of a radiation, then, separating the support, and further irradiating the layer with a radiation to form a protective layer.

As the supports of the protective layer-imparting materials used in the invention, there can be used known supports. Specific examples thereof include films and sheets of resins such as polyethylene terephthalate, polybutylene terephthalate, polyethylene naphthalate, polyamides, polycarbonates, cellulose esters, acetyl cellulose, fluoropolymers, polyethers, polyacetals, polyolefins, polyimides, polyphenylene sulfide, polypropylene, polysulfones, cellophane, polyethylene, polyvinylidene chloride, polyvinyl alcohol, polyesters, polystyrene, ethylene/vinyl acetate copolymers, ethylene/vinyl alcohol copolymers, ionomers, polyvinyl acetal polyvinyl chloride, polyethersulfones, polyetherketones, polyetherimides, polyacrylates and polymethyl methacrylate.

The resin films of the above-mentioned supports may be used either alone or as a laminate obtained by any combination of them. The thickness of these supports is generally preferably within the range of2 μm to 360 μm, and more preferably within the range of 5 μm to 100 μm. However, the thickness is not limited to the above-mentioned range, because the optimum value in handling varies depending on the material of the support. For improving the releasability between the protective layer and the support, an undercoat layer may be given as needed. Of the above-mentioned supports, ones which can withstand the treating temperatures and pressures are preferred. Preferred examples thereof include paper and films of polyethylene terephthalate, polyesters, polycarbonates, polyamides and polyimides. Above all, polyethylene terephthalate, polyethylene naphthalate and polyimide films are particularly preferred.

The radiation-curing compounds used in the invention are cured by the application of radiations. In the invention, the radiations mean all electromagnetic waves and particle beams (particularly, α-ray and β-ray). As the radiations, electron beams, α-ray and ultraviolet to infrared lights are preferred.

The radiation-curing compound used in the invention is contained in a layer containing the compound preferably in an amount of 1% to 90% by weight, and more preferably in an amount of 10% to 80% by weight.

Urethane methacrylate compounds used as the radiation-curing compounds in the invention are methacrylates having urethane bonds in their molecules, and usually synthesized by reacting diols with isocyanate compounds and further subjecting the reaction products to ester interchange reaction with methacrylates. Various products are commercially available, and specific examples thereof are shown below.

(a) Urethane Acrylates and Urethane Methacrylates

Examples thereof include Aronix M-1100, M-1200, M-1210, M-1250, M-1260, M-1300 and M-1310, which are trade names and manufactured by Toagosei Chemical Industry Co., Ltd, Biscoat 812, 823 and 832, which are trade names and manufactured by Osaka Organic Chemical Industry Ltd., and NK Ester U-4HA, U-108A, U-122A, U-200AX, U-340AX, U-1084A, U-6HA, U-324A and UA-100, which are trade names and manufactured by Shin-Nakamura Kagaku Co., Ltd.

The radiation-curing compounds used in the invention are (meth) acrylates of trifunctional or more functional alcohols, which include various compounds and commercially available products. Specific examples thereof are shown below.

(b) Trifunctional or More Functional Radiation-Curing Compounds

Examples thereof include pentaerythritol acrylate, pentaerythritol methacrylate, pentaerythritol tetraacrylate, pentaerythritol tetramethacrylate, trimethylolpropane triacrylate, trimethylolpropane trimethacrylate, dipentaerythritol tetraacrylate, dipentaerythritol tetramethacrylate, dipentaerythritol hexaacrylate, dipentaerythritol hexamethacrylate, dipentaerythritol pentaacrylate, dipentaerythritol pentamethacrylate, pentaerythritol polyacrylate and dipentaerythritol polyacrylate. These trifunctional or more functional radiation curing compounds may be used as a combination of two or more of them, or may be a mixture of them.

Commercially available products include Aronix M-309, M-305, M-309, M-310, M-315, M-320, M-325, M-330 and M-400, which are trade names and manufactured by Toagosei Chemical Industry Co., Ltd., and NK Ester TMPT, A-TMPT, A-TMM-3, A-TMM-3L, A-TMMT and A-9530, which are trade names and manufactured by Shin-Nakamura Kagaku Co., Ltd.

Photopolymerization initiators can be used in the radiation-curing compositions of the invention. Examples of the photopolymerization initiators include benzophenone compounds, acetophenone compounds (e.g., dichloroacetophenone, trichloroacetophenone), light-sensitive halogen compounds (e.g., tribromomethylsulfonylbenzene, 2,4,6-tris(tribromomethyl)triazine), benzoyl compounds, thioxanthone compounds, Michler's ketone, benzyl, benzoin alkyl ethers, benzyl dimethyl ketals, tetramethylthiuram monosulfide and azo compounds. Details of these are described in “Radiation-Curing System”, pages 63 to 147, Sogo Gijutsu Center (1989), JP-A-2000-284403 and JP-A-2000-29168. The content of such a polymerization initiator is preferably from 0.5 part to 30 parts by weight, and particularly preferably from 2 parts to 20 parts by weight, per 100 parts of radiation-curing compound. Less than 0.5 part by weight per 100 parts of radiation-curing compound is unfavorable, because the curing rate is extremely reduced in the irradiation of a radiation.

The radiation-curing composition of the protective layer-imparting material used in the invention may contain a binder. The binder may be either compatible or incompatible with the radiation-curing compound. In general, various film-formable resins can be used. Preferably, a resin is used which has good adhesion to a material to be provided with the protective layer is imparted. The binder and the radiation-curing compound are dissolved or dispersed in an appropriate solvent to prepare a coating solution, which is applied to one face of the above-mentioned support in an amount coated to give a dry film thickness of preferably 0.1 μm to 50 μm, more preferably 0.2 μm to 20 μm, and dried to form the protective layer, thereby obtaining the protective layer-imparting material used in the invention. Such a binder resin is preferably used, for example in an amount of about 20 parts to about 600 parts by weight per 100 parts by weight of radiation-curing compound. As the solvents for dissolving or dispersing the above-mentioned radiation-curing compounds and binders in the invention, there can be freely used known solvents.

As the above-mentioned binder resins, there can be used any of binder resins which have hitherto been known for such a purpose, and usually, binder resins high in heat resistance are selected. Examples thereof include polyamide resins, polyester resins, epoxy resins, polyurethane resins, polyacrylic resins (e.g., polymethylmethacrylate, polyacrylamide, polystyrene-2-acrylonitrile), vinyl resins including polyvinylpyrrolidone, polyvinyl chloride resins (e.g., vinyl chloride-vinyl acetate copolymers), polycarbonate resins, polystyrene, polyphenylene oxide, cellulose resins (e.g., methyl cellulose, ethyl cellulose, carboxymethyl cellulose, cellulose acetate phthalate, cellulose acetate, cellulose acetate propionate, cellulose acetate butyrate, cellulose triacetate), polyvinyl alcohol resins (e.g., polyvinyl alcohol, partially saponified polyvinyl alcohol such as polyvinyl butyral), petroleum resins, rosin derivatives, coumarone-indene resins, terpene resins and polyolefin resins (e.g., polyethylene, polypropylene). The polyvinyl alcohol resins are synthesized by saponifying polyvinyl acetate to polyvinyl alcohol, and reacting butyl aldehyde therewith. Products manufactured by Denki Kagaku Kogyo K.K. and Sekisui Chemical Co., Ltd. are known as commercial products. As to polyvinyl butyral used in the invention, it is preferred that the polyvinyl butyral content is 70% by weight or more and the average degree of polymerization is 500 or more. More preferably, the average degree of polymerization is 1000 or more. As commercially available products, Esrec BL-1, BL-2, BL-3, BL-S, BX-L, BM-1, BM-2, BM-5, BM-S, BH-3, X-1 and BX-7 manufactured by Sekisui Chemical Co., Ltd. are excellent.

In addition to the synthetic resins as described above, mixtures or copolymers thereof can also be used. Specific examples of the copolymers include vinyl acetate-vinyl chloride copolymer resins, acrylic resins and methacrylic resins. The acrylic resins include Dianarl SE-5437, SE-5102, SE-5377, SE-5649, SE-5466, SE-5482, HR-169, 124, HR-1127, HR-116, HR-113, HR-148, HR-131, HR-470, HR-634, HR-606, HR-607, LR-1065, 574, 13, 396, 637, 162, 469, 216, BR-50, BR-52, BR-60, BR-64, BR-73, BR-75, BR-77, BR-79, BR-80, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, BR-117 and BR-118, which are commercial trade names and manufactured by Mitsubishi Rayon Co., Ltd.

In the invention, the releasably provided layer containing the radiation-curing compound (the protective layer: the layer imparted to the surface of the image as the protective layer) may be composed of two or more layers. In that case, a layer close to the support becomes the uppermost layer when the protective layer is formed, so that it is desirable to use a synthetic resin having a high glass transition point, or a matte agent or a hardening agent, thereby constituting a film face hard to be scratched. Further, a release layer may be provided between the layer close to the support and the support. The release layer can be provided using any material so as to become separable from the support, depending on the constitution of the protective layer. In a layer far from the support, a synthetic resin having a lower glass transition point is used, or a high boiling organic solvent and/or a matte agent is reduced in an amount used to the required minimum or not used to improve adhesion to a material to be protected with the protective layer, and a film which protects the curing protective layer and is released in imparting the protective layer may be provided thereon to prevent troubles such as surface stickiness, adhesion to other materials and blocking of itself and other materials. Further, it is desirable that the layer far from the support is designed for the optimum conditions preventing troubles such as surface stickiness, adhesion to other materials and blocking of itself and other materials within such a range that adhesion to a material to be protected with the protective layer is not reduced, by using a synthetic resin having a higher glass transition point, or reducing the amount of a high boiling organic solvent and/or a matte agent used to the required minimum or not using them. Further, for improving the hardness of the radiation-curing compound and adhesion to a material to be protected with the protective layer, it is preferred that the content of additives such as the synthetic resins is changed.

The protective layer containing the radiation-curing compound used in the invention may be hardened with a hardening agent. When the organic solvent series polymers are hardened, hardening agents described in JP-A-61-199997 and JP-A-58-215398 can be used. It is particularly preferred that isocyanate hardening agents are used to the polyester resins.

Various additives such as an antioxidant, an antistatic agent, a dispersing agent, a stabilizer, a pigment, a lubricant and a matte agent can be added as an appropriate combination thereof to the radiation-curing composition used in the invention. A fading inhibitor may be used within such a range that the curing of the radiation-curing compound is practically allowed to be inhibited. The fading inhibitors include, for example, an antioxidant, an ultraviolet absorber and some metal complexes. The antioxidants include, for example, coumarone compounds, coumarin compounds, phenol compounds (for example, hindered phenols), hydroquinone derivatives, hindered amine derivatives and spiroindane compounds. Further, compounds described in JP-A-61-159644 are also effective.

The ultraviolet absorbers include benzotriazole compounds (U.S. Pat. No. 3,533,794), 4-thiazolidone compounds (U.S. Pat. No. 3,352,681), benzophenone compounds (JP-A-56-2784), triazine compounds (JP-A-6-211813, JP-A-8-239368 and JP-A-10-147577), and other compounds described in JP-A-54-48535, JP-A-62-136641 and JP-A-61-88256. Further, ultraviolet-absorbing polymers described in JP-A-62-260152 are also effective. The metal complexes include compounds described in U.S. Pat. Nos. 4,241,155, 4,245,018, columns 3 to 36, and 4,254,195, columns 3to 8, JP-A-62-174741, JP-A-61-88256, pages 27 to 29, JP-A-1-75568 and JP-A-63-199248.

Examples of the useful fading inhibitors are described in JP-A-62-215272, pages 125 to 137. The fading inhibitor or the ultraviolet absorber maybe previously added to the material to be provided with the protective layer, before the protective layer is imparted, so as not to inhibit the curing of the radiation-curing compound of the protective layer-imparting material, or supplied from the outside to the material to be provided with the protective layer, by a method of transferring it from a fading inhibitor-imparting material or an ultraviolet absorber-imparting material. The above-mentioned antioxidant, ultraviolet absorber and metal complex may be used as a combination of them.

Further, various surfactants can be used for aiding coating, improving releasability, improving slipperiness, preventing static electrification and enhancing development. The surfactants available in the invention include nonionic surfactants, anionic surfactants, amphoteric surfactants and cationic surfactants. Specific examples thereof are described in JP-A-62-173463 and JP-A-62-183457. When a release agent, a fading inhibitor, an ultraviolet absorber, a fluorescent brightening agent and another hydrophobic compound are dispersed in a water-soluble binder, a surfactant is preferably used as a dispersing agent. For this purpose, surfactants described in JP-A-59-157636, pages 37 and 38, in addition to the above-mentioned surfactants, are particularly preferably used.

A matte agent can be used in the protective layer-imparting material. The matte agents include compounds described in JP-A-63-274944 and JP-A-63-274952, such as benzoguanamine resin beads, polycarbonate resin beads and AS resin beads, as well as compounds described in JP-A-61-88256, page 29, such as silicon dioxide, polyolefins and polymethacrylates.

An organic fluoro compound may be contained in the protective layer-imparting material, for improving slipperiness, preventing static electrification and improving releasability. Typical examples of the organic fluoro compounds includes fluorine surfactants described in JP-B-57-9053 (the term “JP-B” as used here in means an “examined Japanese patent publication”), columns 8 to 17, JP-A-61-20944 and JP-A-62-135826, and hydrophobic fluorine compounds such as oily fluorine compounds such as fluorine oil and solid fluorine compounds such as an ethylene tetrafluoride resin.

In the protective layer-imparting material used in the invention, a release agent may be contained in the layer close to the support, of layers constituting the protective layer, or the release layer. As the release agents, there can be used anyone of known release agents including solid or waxy materials such as polyethylene wax, amide wax, fine silicone resin powder and fine fluororeisn powder; surfactants such as fluorine surfactants and phosphate surfactants; and oils such as paraffin oil, silicone oil and fluorine oil. As the silicone oil, modified silicone oils such as carboxy-modified, amino-modified, epoxy-modified, polyether-modified and alkyl-modified silicone oils, as well as unmodified silicone oil, can be used either alone or as a combination of two or more of them. Examples thereof include various modified silicone oils described in “Modified Silicone Oils”, technical data published by Shin-Etsu Silicone Co., Ltd., pages 6 to 18B. When used in the organic solvent series binder, amino-modified silicone oil having a group reactable with a crosslinking agent for this binder (for example, a group reactable with an isocyanate) is preferred. When dispersed by emulsification in the water-soluble binder, carboxy-modified silicone oil (for example, X-22-3710 (trade name) manufactured by Shin-Etsu Silicone Co., Ltd.) or epoxy-modified silicone oil (for example, KF-100T (trade name) manufactured by Shin-Etsu Silicone Co., Ltd.) is effectively used.

In the invention, the protective layer-imparting material may have an intermediate layer between the support and the layer adjacent thereto, and between respective layers such as the protective layer and the release layer. Further, an adhesive layer may be provided on the outermost surface in contact with the material to be provided with the protective layer. The intermediate layer is a layer acting as either of a cushion layer and a layer for preventing the diffusion of a colorant, etc., or a layer having these two or more functions. In some cases, it also acts as an adhesive. The layer for preventing the diffusion of a colorant, etc. particularly plays a role of preventing a heat-migratory colorant from being diffused into the support. Although a binder constituting the diffusion prevention layer may be either water-soluble or organic solvent-soluble, a water-soluble binder is preferred. Preferred examples thereof include the binders for the above-mentioned protective layer-imparting materials and gelatin.

In the invention, fine powders of silica, clay, talc, diatomaceous earth, calcium carbonate, calcium sulfate, barium sulfate, aluminum silicate, synthetic zeolite, zinc oxide, lithopone, titanium oxide and alumina may be contained in the protective layer, the cushion layer, the diffusion prevention layer and the adhesive layer constituting the protective layer-imparting material.

When the protective layers are formed on the supports in the protective layer-imparting materials used in the invention, coating solutions for the protective layers can be applied by known methods such as coating, extrusion coating and roll coating using a double roll coater, a slit coater, an air knife coater, a wire bar coater, a slide hopper, a spray coater, a blade coater, a doctor coater, a squeeze coater, a comma coater, a reverse roll coater, a transfer roll coater, an extrusion coater, a curtain coater, a die coater and a gravure coater.

In the invention, solutions of the radiation-curing compounds in various solvents are applied so that the dry thickness of the protective layers becomes preferably 0.1 μm to 50 μm, more preferably 0.2 μm to 20 μm, and still more preferably 0.5 μm to 15 μm.

The protective layer-imparting material used in the invention has the layer containing the radiation-curing compound curable on the support to form a resin, and the layer is provided on the support releasably therefrom. The layer is transferred to the above-mentioned surface of the image by heating and/or the application of pressure.

The temperature of the above-mentioned heating (treating temperature) is preferably from 50° C. to 200° C., and more preferably from 80° C. to 150° C.

Further, the above-mentioned pressure (treating pressure) is preferably from 0.1 kgf/cm² (9.8×10³ Pa) to 50 kgf/cm² (4.9×10⁶ Pa), and more preferably from 0.5 kgf/cm² (4.9×10³ Pa) to 10 kgf/cm² (9.8×10⁶ Pa).

In the invention, the protective layer-imparting material is laid on (transferred to) the material to be provided with the protective layer, by heating and/or the application of pressure. For heating and/or the application of pressure, there can be generally used a heat roller, a laminater, a hot stamp, an electric heating plate and a laser.

Methods for curing the protective layers used in the invention will be described below with reference to general examples, but are not limited thereto. When the irradiation of an electron beam is used, it is preferred that an electron beam accelerator having an acceleration voltage of 100 kV to 1000 kV, more preferably 100 kV to 300 kV, is used and the absorbed dose of one pass is adjusted to 0.5 Mrad to 20 Mrads, in terms of transmission force and curing force. When the acceleration voltage or the exposure dose of the electron beam is lower than this range, the transmission force of the electron beam is too low to sufficiently cure the inside of the support. On the other hand, exceeding this range not only results in deterioration of energy efficiency, but also exerts undesirable effects on the quality, such as a decrease in strength of the supports and degradation of the resins and the additives. The electron beam accelerator may be, for example, any of an electrocurtain system, a scanning type and a double scanning type. In the irradiation of the electron beam, a high oxygen concentration prevents the curing of the radiation-curing compound. It is therefore preferred that the protective layer is irradiated with the electron beam in an atmosphere in which the oxygen concentration is reduced to 600 ppm or less, preferably to 400 ppm or less, by replacing the atmosphere with an inert gas such as nitrogen, helium or carbon dioxide.

In the irradiation of light, a lamp of 80 W/cm2 or more is preferably used. For example, there are a low-pressure mercury lamp, a medium-pressure mercury lamp, a high-pressure mercury lamp and a metal halide lamp. There is also a lamp of an ozoneless type generating little ozone.

Further, laser beams can also be used. For example, there can be used ion gas lasers such as argon and krypton lasers, metal vapor lasers such as copper, gold and cadmium lasers, solid lasers such as ruby and YAG lasers and semiconductor lasers such as a gallium-arsenic laser emitting a laser beam in an infrared region of 750 nm to 870 nm. However, the semiconductor lasers are actually effective in terms of small size, low cost, stability, reliability, durability and easy modulation. When the laser beam is used, the radiation-curing compound is cured only with the laser beam to form the protective layer. However, for curing the radiation-curing compound more effectively, it is preferred that a material strongly absorbing the laser beam is contained in the protective layer-imparting material. When the protective layer-imparting material containing the absorbing material is irradiated with the laser beam, the absorbing material converts light energy to heat energy, which is transmitted to the radiation-curing compound situated nearby, resulting in heating to a temperature at which the radiation-curing compound is easily cured. This laser beam-absorbing material exists as a layer on an adhering face between the radiation-curing compound and the material to be provided with the protective layer, and/or is mixed with the radiation-curing compound. The laser beam is modulated with an electric signal indicating the shape of a face to which the protective layer is imparted, and only the protective layer in a required region is heated and cured to form the protective layer.

Further, heating process can also be used during the curing the layer by irradiation of a radiation to form a protective layer.

In the above-mentioned methods for curing the protective layers used in the invention, it is preferred from the convenience of processes that the irradiation time of the radiation is established to 10 seconds or less.

The colorant used in the invention may be any of a water-soluble dye, an oil-soluble dye and a pigment, and is described in detail below.

The water-based ink used in the invention contains at least one colorant and an aqueous medium, and the term “aqueous medium” means water or a mixture of water and a small amount of water-soluble organic solvent containing additives such as a surfactant, a wetting agent, a stabilizer and a preservative as needed. The water-soluble organic solvent will be described later.

As applicable yellow dyes, any ones can be used. Examples thereof include aryl or heterylazo dyes having phenols, naphthols, anilines, pyrazolone compounds, pyridone compounds or open-chain active methylene compounds as coupling components; azomethine dyes having open-chain active methylene compounds as coupling components; methine dyes such as benzylidene dyes and monomethineoxonol dyes; and quinone dyes such as naphthoquinone dyes and anthraquinone dyes, and the other dye species include quinophthalone dyes, nitro-nitroso dyes, acridine dyes and acridinone dyes.

As applicable magenta dyes, any ones can be used. Examples thereof include aryl or heterylazo dyes having phenols, naphthols or anilines as coupling components; azomethine dyes having pyrazolone compounds or pyrazolotriazole compounds as coupling components; methine dyes such as arylidene dyes, styryl dyes, merocyanine dyes and oxonol dyes; carbonium dyes such as diphenylmethane dyes, triphenylmethane dyes and xanthene dyes; quinone dyes such as naphthoquinone dyes, anthraquinone dyes and anthrapyridone dyes; and condensation polycyclic dyes such as dioxazine dyes.

As applicable cyan dyes, any ones can be used. Examples thereof include azomethine dyes such as indoaniline dyes, indophenol dyes and dyes having pyrrolotriazoles as coupling components; polymethine dyes such as cyanine dyes, oxonol dyes and merocyanine dyes; carbonium dyes such as diphenylmethane dyes, triphenylmethane dyes and xanthene dyes; phthalocyanine dyes; anthraquinone dyes; aryl or heterylazo dyes having phenols, naphthols or anilines as coupling components; and indigo-thioindigo dyes.

The above-mentioned respective dyes may be ones which do not turn yellow, magenta and cyan, respectively, until parts of chromophores dissociate. In that case, counter cations may be inorganic cations such as alkali metal ions and ammonium ions, or organic cations such as pyridinium ions and quaternary ammonium salt ions, or polymer cations having them as partial structures.

The ink used in the invention is further described. The water-soluble dyes used in the invention include direct dyes, acid dyes, food dyes, basic dyes and reactive dyes. Particularly preferred are C.I. Direct Red 2, 4, 9, 23, 26, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, and 247; C.I. Direct Violet 7, 9, 47, 48, 51, 66, 90, 93, 94, 95, 98, 100 and 101; C.I. Direct Yellow 8, 9, 11, 12, 27, 28, 29, 33, 35, 39, 41, 44, 50, 53, 59, 68, 87, 93, 95, 96, 98, 100, 106, 108, 109, 110, 130, 132, 142, 144, 161 and 163; C.I. Direct Blue 1, 10, 15, 22, 25, 55, 67, 68, 71, 76, 77, 78, 80, 84, 86, 87, 90, 98, 106, 108, 109, 151, 156, 158, 159, 160, 168, 189, 192, 193, 194, 199, 200, 201, 202, 203, 207, 211, 213, 214, 218, 225, 229, 236, 237, 244, 248, 249, 251, 252, 264, 270, 280, 288, 289 and 291; C.I. Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173 and 199; C.I. Acid Red 35, 42, 52, 57, 62, 80, 82, 111, 114, 118, 119, 127, 128, 131, 143, 151, 154, 158, 249, 254, 257, 261, 163, 266, 289, 299, 301, 305, 336, 337, 361, 396 and 397; C.I. Acid Violet 5, 34, 43, 47, 48, 90, 103 and 126; C.I. Acid Yellow 17, 19, 23, 25, 39, 40, 42, 44, 49, 50, 61, 64, 76, 79, 110, 127, 135, 143, 151, 159, 169, 174, 190, 195, 196, 197, 199, 218, 219, 222 and 227; C.I. Acid Blue 9, 25, 40, 41, 62, 72, 76, 78, 80, 82, 92, 106, 112, 113, 120, 127:1, 129, 138, 143, 175, 181, 205, 207, 220, 221, 230, 232, 247, 258, 260, 264, 271, 277, 278, 279, 280, 288, 290 and 326; C.I. Acid Black 7, 24, 29, 48, 52:1 and 12; C.I. Reactive Red 3, 13, 17, 19, 21, 22, 23, 24, 29, 35, 37, 40, 41, 43, 45, 49 and 55; C.I. Reactive Violet 1, 3, 4, 5, 6, 7, 8, 9, 16, 17, 22, 23, 24, 26 27, 33 and 34; C.I. Reactive Yellow 2, 3, 13, 14, 15, 17, 18, 23, 24, 25, 26, 27, 29, 35, 37, 41 and 42; C.I. Reactive Blue 2, 3, 5, 8, 10, 13, 14, 15, 17, 18, 19, 21, 25, 26, 27, 28, 29 and 38; C.I. Reactive Black 4, 5, 8, 14, 21, 23, 26, 31, 32 and 34; C.I. Basic Red 12, 13, 14, 15, 18, 22, 23, 24, 25, 27, 29, 35, 36, 38, 39, 45 and 46; C.I. Basic Violet 1, 2, 3, 7, 10, 15, 16, 20, 21, 25, 27, 28, 35, 37, 39, 40 and 48; C.I. Basic Yellow 1, 2, 4, 11, 13, 14, 15, 19, 21, 23, 24, 25, 28, 29, 32, 36, 39 and 40; C.I. Basic Blue 1, 3, 5, 7, 9, 22, 26, 41, 45, 46, 47, 54, 57, 60, 62, 65, 66, 69 and 71; and C.I. Basic lack 8.

The water-soluble dyes preferably used in the invention are compounds represented by general formula (I). Azo dyes represented by general formula (I) will be described in detail.

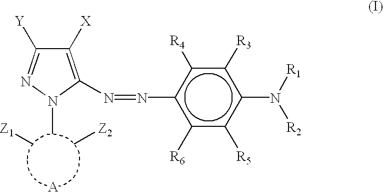

In the above-mentioned general formula (I), X represents an electron attractive group having a Hammett substituent σₚ constant of 0.20 or more, preferably 0.30 to 1.0. Examples of the electron attractive groups X having a σₚ constant of 0.20 or more include an acyl group, an acyloxy group, a carbamoyl group, an alkyloxycarbonyl group, an aryloxycarbonyl group, a cyano group, a nitro group, a dialkylphosphono group, a diaryl-phosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, an alkyl halide group, an alkoxyl halide group, an aryloxyhalide group, an alkylamino halide group, an alkylthio halide group, an aryl group substituted by another electron attractive group having a σₚ constant of 0.20 or more, a heterocyclic group, a halogen atom and a selenocyanate group.

X can further have a substituent group. Such substituent groups include a halogen atom (e.g., chlorine, bromine), a straight or branched chain alkyl group having from 1 to 12 carbon atoms (e.g., methyl, ethyl, propyl, isopropyl, t-butyl), an aralkyl group having from 7 to 18 carbon atoms (e.g., benzyl, phenethyl), an alkenyl group having from 2 to 12 carbon atoms (e.g., vinyl, allyl), a straight or branched chain alkynyl group having from 2 to 12 carbon atoms (e.g., ethynyl, 1-butynyl), a straight or branched chain cycloalkyl group having from 3 to 12 carbon atoms (e.g., cyclopropyl, cyclohexyl), a straight or branched chain cycloalkenyl group having from 3 to 12 carbon atoms (e.g., cyclopentenyl, cyclohexenyl), an aryl group (e.g., phenyl, 4-t-butylphenyl, 2,4-di-t-amylphenyl), a heterocyclic group (e.g., imidazolyl, pyrazolyl, triazolyl, 2-furyl, 2-thienyl, 2-pyrimidinyl, 2-benzothiazolyl), a cyano group, a hydroxyl group, a nitro group, a carboxyl group, an amino group, an alkyloxy group (e.g., methoxy, ethoxy, 2-methoxyethoxy, 2-methanesulfonylethoxy), an aryloxy group (e.g., phenoxy, 2-methylphenoxy, 4-t-butylphenoxy, 3-nitrophenoxy, 3-t-butyloxycarbamoylphenoxy, 3-methoxycarbamoyl), an acylamino group (e.g., acetoamido, benzamido, 4-(3-t-butyl-4-hydroxyphenoxy)butaneamido), an alkylamino group (e.g., methylamino, butylamino, diethylamino, methylbutylamino), an anilino group (e.g., phenylamino, 2-chloroanilino), a ureido group (e.g., phenylureido, methylureido, N,N-dibutylureido), a sulfamoylamino group (e.g., N,N-dipropylsulfamoylamino), an alkylthio group (e.g., methylthio, octylthio, 2-phenoxyethyltio), an arylthio group (e.g., phenylthio, 2-butoxy-5-t-octylphenylthio, 2-carboxyphenylthio), an alkyloxycarbonylamino group (e.g., methoxycarbonylamino), a sulfonamido group (e.g., methanesulfonamido, benzenesulfonamido, p-toluenesulfonamido), a carbamoyl group (e.g., N-ethylcarbamoyl, N,N-dibutyl-carbamoyl), a sulfamoyl group (e.g., N-ethylsulfamoyl, N,N-dipropylsulfamoyl, N,N-diethylsulfamoyl), a sulfonyl group (e.g., methanesulfonyl, octanesulfonyl, benzenesulfonyl, toluenesulfonyl), an alkyloxycarbonyl group (e.g., methoxycarbonyl, butyloxycarbonyl), a heterocyclic oxy group (e.g., 1-phenyltetrazole-5-oxy, 2-tetrahydropyranyloxy), an azo group (e.g., phenylazo, 4-methoxyphenylazo, 4-pivaloylaminophenylazo, 2-hydroxy-4-propanoylphenylazo, an acyloxy group (e.g., acetoxy), a carbamoyloxy group (e.g., N-methylcarbamoyloxy, N-phenylcarbamoyloxy), a silyloxy group (e.g., trimethylsilyloxy, dibutylmethylsilyloxy), an aryloxycarbonylamino group (e.g., phenoxycarbonylamino), an imido group (e.g., N-succinimido, N-phthalimido), a heterocyclic thio group (e.g., 2-benzothiazolylthio, 2,4-diphenoxy-1,3,5-triazole-6-thio, 2-pyridylthio), a sulfinyl group (e.g., 3-phenoxypropylsulfinyl), a phosphonyl group (e.g., phenoxyphosphonyl, octyloxyphosphonyl, phenylphosphonyl), an aryloxycarbonyl group (e.g., phenoxycarbonyl) and an acyl group (e.g., acetyl, 3-phenylpropanoyl, benzoyl).

Preferred examples of the groups represented by X include an acyl group having from 2 to 12 carbon atoms, an acyloxy group having from 2 to 12 carbon atoms, a carbamoyl group having from 1 to 12 carbon atoms, an alkyloxycarbonyl group having from 2 to 12 carbon atoms, an aryloxycarbonyl group having from 7 to 18 carbon atoms, a cyano group, a nitro group, an alkylsulfinyl group having from 1 to 12 carbon atoms, an arylsulfinyl group having from 6 to 18 carbon atoms, an alkylsulfonyl group having from 1 to 12 carbon atoms, an arylsulfonyl group having from 6 to 18 carbon atoms, a sulfamoyl group having from 0 to 12 carbon atoms, an alkyl halide group having from 1 to 12 carbon atoms, an alkyloxy halide group having from 1 to 12 carbon atoms, an alkylthio halide group having from 1 to 12 carbon atoms, an aryloxy halide group having from 7 to 18 carbon atoms, an aryl group having from 7 to 18 carbon atoms substituted by two or more electron attractive groups having a σₚ constant of 0.20 or more, and a heterocyclic group having from 1 to 18 carbon atoms and a nitrogen atom, an oxygen atom or a sulfur atom.

X is more preferably an alkyloxycarbonyl group having from 2 to 12 carbon atoms, a nitro group, a cyano group, an alkylsulfonyl group having from 1 to 12 carbon atoms, an arylsulfonyl group having from 6 to 18 carbon atoms, a carbamoyl group having from 1 to 12 carbon atoms or an alkyl halide group having from 1 to 12 carbon atoms, particularly preferably a cyano group, alkylsulfonyl group having from 1 to 12 carbon atoms or an arylsulfonyl group having from 6 to 18 carbon atoms, and most preferably a cyano group.

In the above-mentioned general formula (I), R₁, R₂, R₃, R₄, R₅, R₆ and Y each independently represents a hydrogen atom, a halogen atom, an alkyl group, a cycloalkyl group, an aralkyl group, an aryl group, a heterocyclic group, a cyano group, a hydroxyl group, a nitro group, an amino group, an alkylamino group, an alkoxyl group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxy-carbonylamino group, an imido group, a heterocyclic thio group, a sulfinyl group, a phosphoryl group, an acyl group or an ionic hydrophilic group.

Above all, a hydrogen atom, a halogen atom, an alkyl group, an aryl group, a cyano group, an alkoxyl group, an amido group, a ureido group, an alkoxycarbonylamino group, a sulfonamido group, a carbamoyl group, a sulfamoyl group and an alkoxylcarbonyl group are particularly preferred.

The halogen atoms represented by R₁ to R₆ and Y include fluorine, chlorine and bromine.

The alkyl groups represented by R₁ to R₆ and Y include alkyl groups having substituent groups and unsubstituted alkyl groups. The alkyl groups are preferably alkyl groups each having from 1 to 12 carbon atoms. Examples of the substituent groups include a hydroxyl group, an alkoxyl group, a cyano group, a halogen atom and an ionic hydrophilic group. Examples of the alkyl groups include methyl, ethyl, butyl, isopropyl, t-butyl, hydroxyethyl, methoxyethyl, cyanoethyl, tri-fluoromethyl, 3-sulfopropyl and 4-sulfobutyl.

The cycloalkyl groups represented by R₁ to R₆ and Y include cycloalkyl groups having substituent groups and unsubstituted cycloalkyl groups. The cycloalkyl groups are preferably cycloalkyl groups each having from 5 to 12 carbon atoms. Examples of the substituent groups include an ionic hydrophilic group. Examples of the cycloalkyl groups include cyclohexyl.

The aralkyl groups represented by R, to R₆ and Y include aralkyl groups having substituent groups and unsubstituted aralkyl groups. The aralkyl groups are preferably aralkyl groups each having from 7 to 12 carbon atoms. Examples of the substituent groups include an ionic hydrophilic group. Examples of the aralkyl groups include benzyl and 2-phenethyl.

The aryl groups represented by R₁ to R₆ and Y include aryl groups having substituent groups and unsubstituted aryl groups. The aryl groups are preferably aryl groups each having from 7 to 12 carbon atoms. Examples of the substituent groups include an alkyl group, an alkoxyl group, a halogen atom, an alkylamino group and an ionic hydrophilic group. Examples of the aryl groups include phenyl, p-tolyl, p-methoxyphenyl, o-chlorophenyl and m-(3-sulfopropylamino)phenyl.

The heterocyclic groups represented by R₁ to R₆ and Y include heterocyclic groups having substituent groups and unsubstituted heterocyclic groups. The heterocyclic groups are preferably 5-or 6-membered heterocyclic groups. Examples of the substituent groups include an ionic hydrophilic group. Examples of the heterocyclic groups include 2-pyridyl, 2-thienyl and 2-furyl.

The alkylamino groups represented by R₁ to R₆ and Y include alkylamino groups having substituent groups and unsubstituted alkylamino groups. The alkylamino groups are preferably alkylamino groups each having from 1 to 6 carbon atoms. Examples of the substituent groups include an ionic hydrophilic group. Examples of the alkylamino groups include methylamino and diethylamino.

The alkoxyl groups represented by R₁ to R₆ and Y include alkoxyl groups having substituent groups and unsubstituted alkoxyl groups. The alkoxyl groups are preferably alkoxyl groups each having from 1 to 12 carbon atoms. Examples of the substituent groups include an alkoxyl group, a hydroxyl group and an ionic hydrophilic group. Examples of the alkoxyl groups include methoxy, ethoxy, isopropoxy, methoxyethoxy, hydroxyethoxy and 3-carboxypropoxy.

The aryloxy groups represented by R₁ to R₆ and Y include aryloxy groups having substituent groups and unsubstituted aryloxy groups. The aryloxy groups are preferably aryloxy groups each having from 6 to 12 carbon atoms. Examples of the substituent groups include an alkoxyl group and an ionic hydrophilic group. Examples of the aryloxy groups include phenoxy, p-methoxyphenoxy and o-methoxyphenoxy.

The amido groups represented by R₁ to R₆ and Y include amido groups having substituent groups and unsubstituted amido groups. The amido groups are preferably amido groups each having from 2 to 12 carbon atoms. Examples of the substituent groups include an ionic hydrophilic group. Examples of the amido groups include acetamido, propionamido, benzamido and 3,5-disulfobenzamido.

The arylamino groups represented by R₁ to R₆ and Y include arylamino groups having substituent groups and unsubstituted arylamino groups. The arylamino groups are preferably arylamino groups each having from 6 to 12 carbon atoms. Examples of the substituent groups include a halogen atom and an ionic hydrophilic group. Examples of the arylamino groups include anilino and 2-chloroanilino.

The ureido groups represented by R₁ to R₆ and Y include ureido groups having substituent groups and unsubstituted ureido groups. The ureido groups are preferably ureido groups each having from 1 to 12 carbon atoms. Examples of the substituent groups include an alkyl group and an aryl group. Examples of the ureido groups include 3-methylureido, 3,3-dimethylureido and 3-phenylureido.

The sulfamoylamino groups represented by R₁ to R₆ and Y include sulfamoylamino groups having substituent groups and unsubstituted sulfamoylamino groups. Examples of the substituent groups include an alkyl group. Examples of the sulfamoylamino groups include N,N-dipropylsulfamoylamino.

The alkylthio groups represented by R₁ to R₆ and Y include alkylthio groups having substituent groups and unsubstituted alkylthio groups. The alkylthio groups are preferably alkylthio groups each having from 1 to 12 carbon atoms. Examples of the substituent groups include an ionic hydrophilic group. Examples of the alkylthio groups include methylthio and ethylthio.

The arylthio groups represented by R₁ to R₆ and Y include arylthio groups having substituent groups and unsubstituted arylthio groups. The arylthio groups are preferably arylthio groups each having from 6 to 12 carbon atoms. Examples of the substituent groups include an alkyl group and an ionic hydrophilic group. Examples of the arylthio groups include phenylthio and p-tolylthio.

The alkoxycarbonylamino groups represented by R₁ to R₆ and Y include alkoxycarbonylamino groups having substituent groups and unsubstituted alkoxycarbonylamino groups. The alkoxycarbonylamino groups are preferably alkoxycarbonylamino groups each having from 2 to 12 carbon atoms. Examples of the substituent groups include an ionic hydrophilic group. Examples of the alkoxycarbonylamino groups include ethoxycarbonylamino.

The sulfonamido groups represented by R₁ to R₆ and Y include sulfonamido groups having substituent groups and unsubstituted sulfonamido groups. The sulfonamido groups are preferably sulfonamido groups each having from 1 to 12 carbon atoms. Examples of the substituent groups include an ionic hydrophilic group. Examples of the sulfonamido groups include methanesulfonamido, benzenesulfonamido and 3-carboxybenzenesulfonamido.

The carbamoyl groups represented by R₁ to R₆ and Y include carbamoyl groups having substituent groups and unsubstituted carbamoyl groups. Examples of the substituent groups include an alkyl group. Examples of the carbamoyl groups include methylcarbamoyl and dimethylcarbamoyl.

The sulfamoyl groups represented by R₁ to R₆ and Y include sulfamoyl groups having substituent groups and unsubstituted sulfamoyl groups. Examples of the substituent groups include an alkyl group. Examples of the sulfamoyl groups include dimethylsulfamoyl and di-(2-hydroxyethyl)sulfamoyl.

The sulfonyl groups represented by R₁ to R₆ and Y include methanesulfonyl and phenylsulfonyl.

The alkoxycarbonyl groups represented by R₁ to R₆ and Y include alkoxycarbonyl groups having substituent groups and unsubstituted alkoxycarbonyl groups. The alkoxycarbonyl groups are preferably alkoxycarbonyl groups each having from 2 to 12 carbon atoms. Examples of the substituent groups include an ionic hydrophilic group. Examples of the alkoxycarbonyl groups include methoxycarbonyl and ethoxycarbonyl.

The heterocyclic oxy groups represented by R₁ to R₆ and Y include heterocyclic oxy groups having substituent groups and unsubstituted heterocyclic oxy groups. The heterocyclic oxy groups are preferably heterocyclic oxy groups each having a 5- or 6-membered heterocycle. Examples of the substituent groups include a hydroxyl group and an ionic hydrophilic group. Examples of the heterocyclic oxy groups include 2-tetrahydropyranyloxy.

The azo groups represented by R₁ to R₆ and Y include azo groups having substituent groups and unsubstituted azo groups. Examples of the azo groups include p-nitrophenylazo.

The acyloxy groups represented by R₁ to R₆ and Y include acyloxy groups having substituent groups and unsubstituted acyloxy groups. The acyloxy groups are preferably acyloxy groups each having from 1 to 12 carbon atoms. Examples of the substituent groups include an ionic hydrophilic group. Examples of the acyloxy groups include acetoxy and benzoyloxy.

The carbamoyloxy groups represented by R₁ to R₆ and Y include carbamoyloxy groups having substituent groups and unsubstituted carbamoyloxy groups. Examples of the substituent groups include an alkyl group. Examples of the carbamoyloxy groups include N-methylcarbamoyloxy.

The silyloxy groups represented by R₁ to R₆ and Y include silyloxy groups having substituent groups and unsubstituted silyloxy groups. Examples of the substituent groups include an alkyl group. Examples of the silyloxy groups include trimethylsilyloxy.

The aryloxycarbonyl groups represented by R₁ to R₆ and Y include aryloxycarbonyl groups having substituent groups and unsubstituted aryloxycarbonyl groups. The aryloxycarbonyl groups are preferably aryloxycarbonyl groups each having from 7 to 12 carbon atoms. Examples of the substituent groups include an ionic hydrophilic group. Examples of the aryloxycarbonyl groups include phenoxycarbonyl.

The aryloxycarbonylamino groups represented by R₁ to R₆ and Y include aryloxycarbonylamino groups having substituent groups and unsubstituted aryloxycarbonylamino groups. The aryloxycarbonylamino groups are preferably aryloxycarbonylamino groups each having from 7 to 12 carbon atoms. Examples of the substituent groups include an ionic hydrophilic group. Examples of the aryloxycarbonylamino groups include phenoxycarbonylamino.

The imido groups represented by R₁ to R₆ and Y include imido groups having substituent groups and unsubstituted imido groups. Examples of the imido groups include N-phthalimido and N-succinimido.

The heterocyclic thio groups represented by R₁ to R₆ and Y include heterocyclic thio groups having substituent groups and unsubstituted heterocyclic thio groups. It is preferred that the heterocyclic thio groups have 5- or 6-membered heterocycles. Examples of the substituent groups include an ionic hydrophilic group. Examples of the heterocyclic thio groups include 2-pyridylthio.

The sulfinyl groups represented by R₁ to R₆ and Y include sulfinyl groups having substituent groups and unsubstituted sulfinyl groups. Examples of the sulfinyl groups include phenylsulfinyl.

The phosphoryl groups represented by R₁ to R₆ and Y include phosphoryl groups having substituent groups and unsubstituted phosphoryl groups. Examples of the phosphoryl groups include phenoxyphosphoryl and phenylphosphoryl.

The acyl groups represented by R₁ to R₆ and Y include acyl groups having substituent groups and unsubstituted acyl groups. The acyl groups are preferably acyl groups each having from 1 to 12 carbon atoms. Examples of the substituent groups include anionichydrophilic group. Examples of the acyl groups include acetyl and benzoyl.

The ionic hydrophilic groups represented by R₁ to R₆ and Y include a carboxyl group, a sulfo group and a quaternary ammonium group. As the ionic hydrophilic groups, a carboxyl group and a sulfo group are preferred, and a sulfo group is particularly preferred. The carboxyl group and the sulfo group may be in the salt state, and examples of counter ions forming the salts include alkali metal ions (for example, a sodium ion and a potassium ion) and organic cations (for example, a tetramethylguanidinium ion).

In the above-mentioned general formula (I), R₁ and R₂, R₃ and R₁, or R₅ and R₂ may combine with each other to form a ring. Preferred examples of the rings formed are shown below:

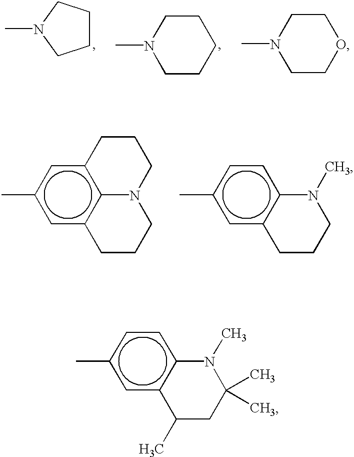

In the above-mentioned general formula (I), A represents a non-metallic atomic group necessary for forming a 5- to 8-membered ring (a ring represented by A is hereinafter referred to as “ring A” in some cases). Ring A may be a saturated ring, or have an unsaturated bond. The above-mentioned non-metallic atomic group is preferably a group composed of one or a combination of two or more selected from a nitrogen atom, an oxygen atom, a sulfur atom and a carbon atom, and particularly preferably a group composed of only a carbon atom.

Ring A includes, for example, a benzene ring, a cyclopentane ring, a cyclohexane ring, a cycloheptane ring, a cyclooctane ring, a cyclohexene ring, a pyridine ring, a piperazine ring, an oxane ring and a thiane ring. Of these rings, groups which can further have substituent groups may be further substituted by the substituent groups illustrated for the above-mentioned substituent groups R₁ to R₆, Y, Z₁ and

At least three of the non-metallic atomic groups forming ring A are substituted by an N atom of a pyrazole ring, Z₁ and Z₂, respectively, and an atom substituted by the N atom of the pyrazole ring is adjacent to both atoms substituted by Z₁ and Z₂.

Ring A is preferably a benzene ring, and more preferably a benzene ring substituted by an ionic hydrophilic group (which may be substituted by the above-mentioned substituent group) at the 4-position to the N atom of the pyrazole ring, as well as the N atom of the pyrazole ring, Z₁ and Z₂.

In the above-mentioned formula (I), Z₁ and Z₂ each independently represents a hydrogen atom, a halogen atom, an alkyl group, a cycloalkyl group, an aralkyl group, an aryl group, a heterocyclic group, a cyano group, a hydroxyl group, a nitro group, an amino group, an alkylamino group, an alkoxyl group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a sulfinyl group, a phosphoryl group, an acyl group or an ionic hydrophilic group.

Above all, preferred are a halogen atom, an alkyl group, an aryl group, a cyano group, an alkoxyl group, an amido group, a ureido group, an alkoxycarbonylamino group, a sulfonamido group, a carbamoyl group, a sulfamoyl group, an alkoxycarbonyl group and an ionic hydrophilic group, particularly preferred are a halogen atom, an alkyl group and an alkoxyl group, and most preferred is a halogen atom.

The respective groups represented by Z₁ and Z₂ have the same meaning as given for the respective groups represented by R₁ to R₆ and Y, and preferred examples thereof are also the same as with the groups represented by R₁ to R₆ and Y.

Of the azo dyes represented by the above-mentioned general formula (I), azo dyes represented by the following general formula (II) are preferred. The azo dyes represented by general formula (II) used in the invention will be described in detail below.

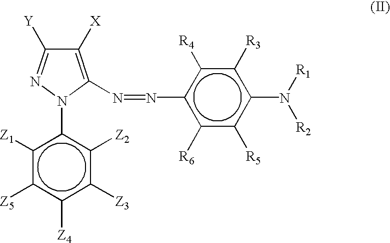

In the above-mentioned general formula (II), X, Y, Z₁, Z₂, R₁, R₂, R₃, R₄, R₅ and R₆ have the same meanings as given for X, Y, Z₁, Z₂, R₁, R₂, R₃, R₄, R₅ and R₆ in the above-mentioned general formula (I), and preferred examples thereof are also the same as with X, Y, Z₁, Z₂, R₁, R₂, R₃, R₄, R₅ and R₆ in the above-mentioned general formula (I).

In the above-mentioned general formula (II), Z₃, Z₄ and Z₅ each independently represents a hydrogen atom, a halogen atom, an alkyl group, a cycloalkyl group, an aralkyl group, an aryl group, a heterocyclic group, a cyano group, a hydroxyl group, a nitro group, an amino group, an alkylamino group, an alkoxyl group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a sulfinyl group, a phosphoryl group, an acyl group or an ionic hydrophilic group.

Above all, particularly preferred are a hydrogen atom, a halogen atom, an alkyl group, an aryl group, a cyano group, an alkoxyl group, an amido group, a ureido group, an alkoxycarbonylamino group, a sulfonamido group, a carbamoyl group, a sulfamoyl group, an alkoxycarbonyl group and an ionic hydrophilic group.

Specific examples of Z₃, Z₄ and Z₅ include the groups described for R₁ to R₆and Y of the above-mentioned general formula (I).

More preferably, Z₃ and Z₅ are each a hydrogen atom, a halogen atom or an alkyl group, and of these, a hydrogen atom is particularly preferred.

As to Z₄, more preferred are a hydrogen atom, a halogen atom, an alkyl group, an aryl group, a cyano group, an alkoxyl group, an amido group, a ureido group, a sulfonamido group, a carbamoyl group, a sulfamoyl group, an alkoxycarbonyl group and an ionic hydrophilic group. Of these, a hydrogen atom, an alkyl group and an ionic hydrophilic group are particularly preferred, and an ionic hydrophilic group is most preferred.

As the particularly preferred substituent groups in the azo dye represented by general formula (II), X is preferably a cyano group, an alkylsulfonyl group having from 1 to 12 carbon atoms or an arylsulfonyl group having from 6 to 18 carbon atoms, and particularly preferably a cyano group. Y is a hydrogen atom, an alkyl group or an aryl group, and of these, a hydrogen atom is particularly preferred. R₁ and R₂ are each an alkyl group (which may have an ionic hydrophilic group as a substituent group) or an aryl group (which may have an ionic hydrophilic group as a substituent group). R₃, R₄ and R₅ are each a hydrogen atom, and R₆ is an amido group (which may have an ionic hydrophilic group as a substituent group). Z₁ and Z₂ are each a halogen atom or an alkyl group. Z₃ and Z₅ are each a hydrogen atom, a halogen atom or an alkyl group, and of these, a hydrogen atom is particularly preferred. Z₄ is a hydrogen atom, a halogen atom, a sulfonamido group, a carbamoyl group, a sulfamoyl group, an alkoxycarbonyl group or an ionic hydrophilic group, and of these, an ionic hydrophilic group is particularly preferred.

As to a preferred combination of substituent groups in the compound represented by the above-mentioned general formula (II), a compound is preferred in which at least one of various substituent groups is the above-mentioned preferred group, a compound is more preferred in which more of various substituents are the above-mentioned preferred groups, and a compound is most preferred in which all substituent groups are the above-mentioned preferred group.

However, at least one of R₁, R₂, R₃, R₄, R₅, R₆, X, Y, Z₁, Z₂ and A in the above-mentioned general formula (I) and at least one of R₁, R₂, R₃, R₄, R₅, R_{6,} X, Y, Z₁, Z₂, Z₃, Z₄ and Z₅ in the above-mentioned general formula (II) each represents an ionic hydrophilic group, or has an ionic hydrophilic group as a substituent group. The azo dye represented by the above-mentioned general formula (I) or (II) has at least one ionic hydrophilic group in its molecule, so that the solubility or dispersibility thereof in an aqueous solvent is improved. The ionic hydrophilic groups as the substituent groups for R₁ to R₆, X, Y and Z₁ to Z₅ include a sulfo group, a carboxyl group and a quaternary ammonium group. Above all, a sulfo group and a carboxyl group are preferred, and a sulfo group is particularly preferred. The carboxyl group and the sulfo group may be in the salt state, and examples of counter ions forming the salts include alkali metal ions (for example, a sodium ion and a potassium ion) and organic cations (for example, a tetramethylguanidinium ion).

It is more preferred that the azo dye represented by the above-mentioned general formula (II) has a structure represented by the following general formula (III):

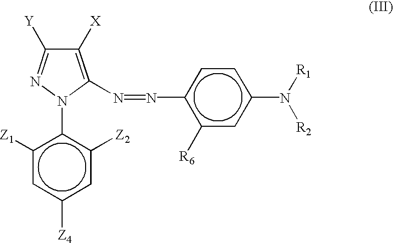

In the above-mentioned general formula (III), X, Y, Z₁, Z₂, Z₄, R₁, R₂ and R₆ have the same meanings as given for X, Y, Z₁, Z₂, Z₄, R₁, R₂ and R₆ in general formula (II), and preferred examples thereof are also the same as with X, Y, Z₁, Z₂, Z₄, R₁, R₂ and R₆ in general formula (II).

As particularly preferred combinations of the substituent groups of the azo dyes represented by the above-mentioned general formula (III), X is a cyano, an alkylsulfonyl group having from 1 to 12 carbon atoms or an arylsulfonyl group having from 6 to 18 carbon atoms, and particularly preferably a cyano group. Y is a hydrogen atom, an alkyl group or an aryl group, and of these, a hydrogen atom is particularly preferred. R₁ and R₂ are each an alkyl group (which may have an ionic hydrophilic group as a substituent group) or an aryl group (which may have an ionic hydrophilic group as a substituent group). R₆ is an amido group (which may have an ionic hydrophilic group as a substituent group). Z₁ and Z₂ are each a halogen atom or an alkyl group. Z₄ is a hydrogen atom, a halogen atom, a sulfonamido group, a carbamoyl group, a sulfamoyl group, an alkoxycarbonyl group or an ionic hydrophilic group, and of these, an ionic hydrophilic group is particularly preferred.

As to a preferred combination of substituent groups in the compound represented by the above-mentioned general formula (III), a compound is preferred in which at least one of various substituent groups is the above-mentioned preferred group, a compound is more preferred in which more of various substituents are the above-mentioned preferred groups, and a compound is most preferred in which all substituent groups are the above-mentioned preferred group.

Specific examples of the azo dyes represented by the above-mentioned general formulas (I) and (II) (example compounds 101 to 143) are shown below, but the azo dyes used in the invention are not limited thereto.

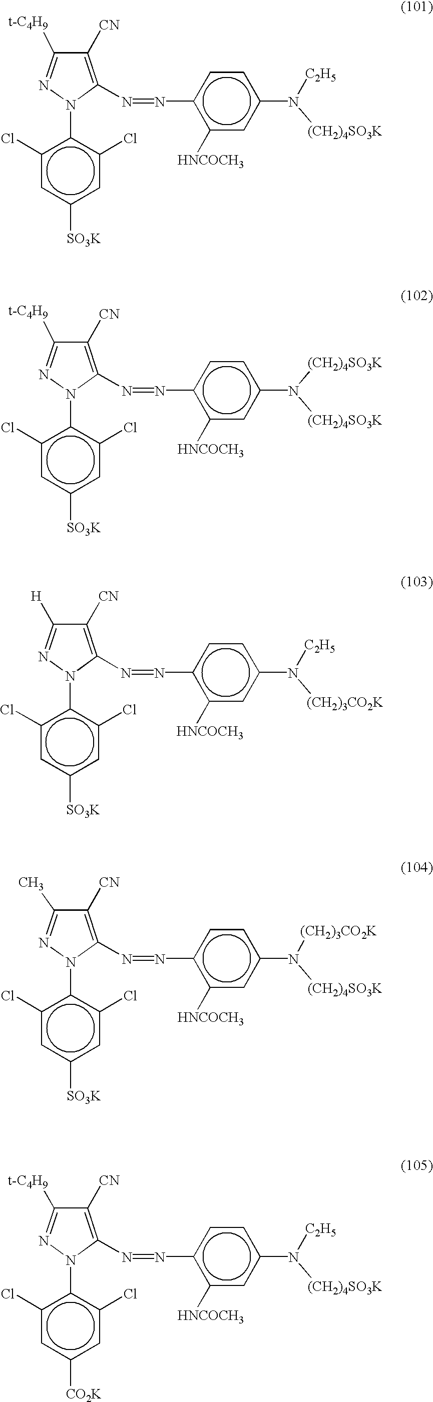

As to the oil-soluble dyes used in the invention, there is no particular limitation on the solubility in water.

Preferred examples of the oil-soluble dyes include but are not limited to C.I. Solvent Black 3, 7, 27, 29 and 34; C.I. Solvent Yellow 14, 16, 19, 29, 30, 56, 82, 93 and 162; C.I. Solvent Red 1, 3, 8, 18, 24, 27, 43, 49, 51, 72, 73, 109, 122, 132 and 218; C.I. Solvent Violet 3; C.I. Solvent Blue 2, 11, 25, 35, 38, 67 and 70; C.I. Solvent Green 3 and 7; and C.I. Solvent Orange 2. Of these, particularly preferred are Nubian Black PC-0850, Oil Black HBB, Oil Yellow 129, Oil Yellow 105 Oil Pink 312, Oil Red 5B, Oil Scarlet 308, Vali Fast Blue 2606 and Oil Blue BOS (manufactured by Orient Chemical Industries Co., Ltd.), Aizen Spilon Blue GNH (manufactured by Hodogaya Chemical Co., Ltd.), and Neopen Yellow 075,Neopen Mazenta SE1378, Neopen Blue 808, Neopen Blue FF4012 and Neopen Cyan FF4238 (manufactured by BASF AG).

In the invention, disperse dyes can also be used as long as they dissolve in aqueous-immiscible organic solvents. Preferred examples thereof include C.I. Disperse Yellow 5, 42, 54, 64, 79, 82, 83, 93, 99, 100, 119, 122, 124, 126, 160, 184, 186, 198, 199, 201, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and C.I. Disperse Green 6:1 and 9.

Particularly preferred examples of the oil-soluble dyes include azo and azomethine dyes represented by the following formulas (1) and (2). The dyes of formula (2) are known as dyes produced from couplers and developing agents by oxidation in photographic materials.

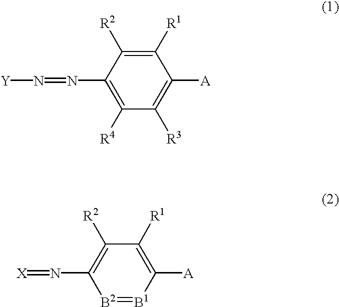

In formulas (1) and (2), R¹, R², R³and R⁴each independently represents a hydrogen atom, a halogen atom, an aliphatic group, an aromatic group, a heterocyclic group, a cyano group, a hydroxyl group, a nitro group, an amino group, an alkylamino group, an alkoxyl group, an aryloxy group, an amido group, an arylamino group, a ureido group, a sulfamoylamino group, an alkylthio group, an arylthio group, an alkoxycarbonylamino group, a sulfonamido group, a carbamoyl group, a sulfamoyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a sulfinyl group, a phosphoryl group, an acyl group, a carboxyl group or a sulfo group. A represents —NR⁵R⁶or a hydroxyl group, and R⁵ and R⁶ each independently represents a hydrogen atom, an aliphatic group, an aromatic group and a heterocyclic group. A is preferably —NR⁵R⁶. R⁵ and R⁶ may combine with each other to form a ring. B¹ represents ═C(R³)— or ═N—, and B² represents —C(R⁴)═ or —N═. It is preferred that B¹ and B² are not —N═ at the same time, and it is more preferred that B¹ is ═C(R³)— and B² is —C(R⁴)═. R¹ and R⁵, R³ and R⁶, and/or R¹ and R² may combine with each other to form an aromatic ring or a heterocyclic ring. X represents a residue of a color photographic coupler, and Y represents a unsaturated heterocyclic group.

R⁵ and R⁶ are each independently preferably a hydrogen atom, an aliphatic group, an aromatic group or a heterocyclic group, more preferably a hydrogen atom, an alkyl group, a substituted alkyl group, aryl group or a substituted aryl group, and most preferably a hydrogen atom, an alkyl group having from 1 to 18 carbon atoms or a substituted alkyl group having from 1 to 18 carbon atoms. R² is preferably a hydrogen atom, a halogen atom, an aliphatic group, an alkoxyl group, an aryloxy group, an amido group, a ureido group, a sulfamoylamino group, an alkoxycarbonylamino group or a sulfonamido group.

In this specification, the aliphatic group means an alkyl group, a substituted alkyl group, an alkenyl group, a substituted alkenyl group, an alkynyl group, a substituted alkynyl group, an aralkyl group and a substituted aralkyl group.

The aliphatic group may be branched or form a ring. The carbon atom number of the aliphatic group is preferably from 1 to 20, and more preferably from 1 to 18. An aryl moiety of the aralkyl group or the substituted aralkyl group is preferably phenyl or naphthyl, and particularly preferably phenyl.

Examples of the substituent groups of an alkyl moiety of the substituted alkyl group, the substituted alkenyl group, the substituted alkynyl group or the substituted aralkyl group include the substituent groups mentioned for R¹, R², R³ and R⁴.

Examples of the substituent groups of an aryl moiety of the substituted aralkyl group are the same as examples of substituent groups of the following substituted aryl groups.

In the specification, the aromatic group means an aryl group and a substituted aryl group. The aryl group is preferably phenyl or naphthyl, and particularly preferably phenyl.

An aryl moiety of the substituent aryl group is the same as with the above-mentioned aryl group. Examples of the substituent groups of the substituted aryl group include the substituent groups mentioned for R¹, R², R³ and R⁴.

The unsaturated heterocyclic group represented by Y in formula (1) is preferably a 5- or 6-membered unsaturated heterocycle. An aliphatic ring, an aromatic ring or another heterocycle may be condensed with the heterocylce. Examples of heteroatoms of the heterocycle include N, O and S. Examples of the saturated heterocycles include a pyrrolidine ring and a morpholine ring. Examples of the unsaturated heterocycles include a pyrazole ring, an imidazole ring, a thiazole ring, an isothiazole ring, a thiadiazole ring, a thiophene ring, a benzothiazole ring, a benzoxazole ring, benzoisothiazole ring, a pyrimidine ring, a pyridine ring and a quinoline ring.

The heterocyclic groups may have the substituent groups mentioned for the above-mentioned R¹ to R⁴.

The couplers represented by X in formula (2) are preferably the following couplers:

Yellow couplers: Couplers described in U.S. Pat. Nos. 3,933,501, 4,022,620, 4,326,024, 4,401,752 and 4,248,961, JP-B-58-10739, British Patents 1,425,020 and 1,476,760, U.S. Pat. Nos. 3,973,968, 4,314,023 and 4,511,649, and EP-A-249, 473, couplers represented by formulas (I) and (II) of EP-A-502, 424, couplers represented by formulas (1) and (2) of EP-A-513,496 (particularly, Y-28on page 18), couplers represented by formula (I) of claim 1 of EP-A-568,037, couplers represented by general formula (I) in lines45 to 55in column 1 of U.S. Pat. No. 5,066,576, couplers represented by general formula (I) in paragraph 0008 of JP-A-4-274425, couplers described in claim 1 on page 40 of EP-A-498,381 (particularly, D-35 on page 18), couplers represented by formula (Y) on page 4 of EP-A-447,969 (particularly, Y-1 on page 17 and Y-54 on page 41), and couplers represented by formulas (II) to (IV) in lines 36 to 58 in column 7 of U.S. Pat. No. 4,476,219 (particularly, II-17 and II-19 in column 17, and II-24 in column 19).

Magenta couplers: Couplers described in U.S. Pat. Nos. 4,310,619 and 4,351,897, European Patent 73,636, U.S. Pat. Nos. 3,061,432 and 3,725,067, Research Disclosure, No. 24220 (June, 1984), ibid., No. 24230 (June, 1984), JP-A-60-33552, JP-A-60-43659, JP-A-61-72238, JP-A-60-35730, JP-A-55-118034, JP-A-60-185951, U.S. Pat. Nos. 4,500,630, 4,540,654 and 4,556,630, WO88/04795, JP-A-3-39737 (L-57 (page 11, lower right), L-68 (page 12, lower right), L-77 (page 13, lower right)), [A-4]-63 (page 143) and [A-4]-73 and -75 (page 139) of European Patent 456,257, M-4 andM-6 (page 26) andM-7 (page 27) of European Patent 486,965, M-45 (page 19) of EP-A-571,959, M-1 (page 6) of JP-A-5-204106, M-22 in paragraph 0237 of JP-A-4-362631, U.S. Patents 3,061,432 and 3,725,067.

Cyan couplers: Couplers described in U.S. Pat. Nos. 4,052,212, 4,146,396, 4,228,233 and 4,296,200, European Patent 73,636, CX-1, −3, −4, −5, −11, −12, −14 and −15 (pages 14 to 16) of JP-A-4-204843, C-7 and −10 (page 35), −34 and −35 (page 37), and I-1 and I-17 (pages 42 and 43) of JP-A-4-43345, and couplers represented by general formula (Ia) or (Ib) in claim 1 of JP-A-6-67385.

In addition, couplers described in JP-A-62-215272 (page 91), JP-A-2-33144 (pages 3 and 30) and EP-A-355, 660 (pages 4, 5, 45 and 47) are also preferred.

Of the dyes represented by formula (1), dyes represented by the following formula (3) are particularly preferred as the magenta dyes:

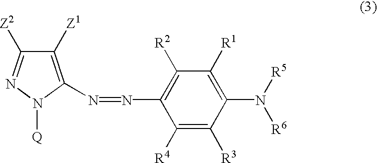

wherein Z¹ represents an electron attractive group having a Hammett substituent σₚ constant of 0.20 or more. Z¹ is preferably an electron attractive group having a Hammett substituent σₚ constant of 0.30 to 1.0. Preferred examples of the substituent groups include electron attractive substituent groups described later. Above all, preferred are an acyl group having from 2 to 12 carbon atoms, an alkyloxycarbonyl group having from 2 to 12 carbon atoms, a nitro group, a cyano group, an alkylsulfonyl group having from 1 to 12 carbon atoms, an arylsulfonyl groups having from 6 to 18 carbon atoms, a carbamoyl group having from 1 to 12 carbon atoms and an alkyl halide group having from 1 to 12 carbon atoms. Particularly preferred are a cyano group, an alkylsulfonyl group having from 1 to 12 carbon atoms and an arylsulfonyl groups having from 6 to 18 carbon atoms, and most preferred is a cyano group.

R¹ to R⁶ have the same meaning as given for formula (1). Z² represents a hydrogen atom, an aliphatic group or an aromatic group. Q represents a hydrogen atom, an aliphatic group, an aromatic group or a heterocyclic group. Above all, Q is preferably a group composed of a non-metallic atomic group necessary for forming a 5- to 8-membered ring. In particular, an aromatic group and a heterocyclic group are preferred. The above-mentioned 5- to 8-membered ring may be substituted, be a saturated ring, or have an unsaturated bond. Preferred examples of the non-metallic atoms include a nitrogen atom, an oxygen atom, a sulfur atom and a carbon atom. Specific examples of such ring structures include, for example, a benzene ring, a cyclohexane ring, a cyclobutane ring, a cyclooctane ring, a cyclohexene ring, a pyridine ring, a pyrimidine ring, a pyrazine ring, a pyridazine ring, a triazine ring, an imidazole ring, a benzoimidazole ring, an oxazole ring, a benzoxazole ring, an oxane ring, a sulfolane ring and a thiane ring. When these rings further have substituent groups, the substituent groups include the groups illustrated for the above-mentioned substituent groups R¹ to R⁴.

Preferred dye structures represented by formula (3) are described in Japanese Patent Application No. 2000-80733.

Of the dyes represented by formula (2), dyes represented by the following formula (4) are particularly preferably used as the magenta dyes:

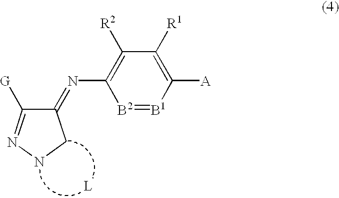

wherein G represents a hydrogen atom, an aliphatic group, an aromatic group, a heterocyclic group, a cyano group, an alkoxyl group, an aryloxy group, an alkylthio group, an arylthio group, an ester group, an amino group, a carbamoyl group, a sulfonyl group, a sulfamoyl group, a ureido group, an urethane group, an acyl group, an amido group or a sulfonamido group; R¹, R², A, B¹ and B² have the same meanings as given for formula (2), and preferred examples thereof are also the same as with formula (2); and L represents an atomic group forming a 5- or 6-membered nitrogen-containing heterocycle which may be substituted by at least one of an aliphatic group, an aromatic group, a heterocyclic group, a cyano group, an alkoxyl group, an aryloxy group, an alkylthio group, an arylthio group, an ester group, an amino group, a carbamoyl group, a sulfonyl group, a sulfamoyl group, a ureido group, an urethane group, an acyl group, an amido group and a sulfonamido group, and this heterocycle may further form a condensed ring with another ring.

Of the compounds represented by formula (4), A is preferably —NR⁵R⁶, and L preferably forms a 5-membered nitrogen-containing heterocycle. Examples of the 5-membered nitrogen-containing heterocycles include an imidazole ring, a triazole ring and tetrazole ring.

Examples of the magenta dyes represented by formulas (1) and (2) are enumerated below, but they are only illustrative of the invention in detail, and it is to be understood that the invention be not limited thereby.

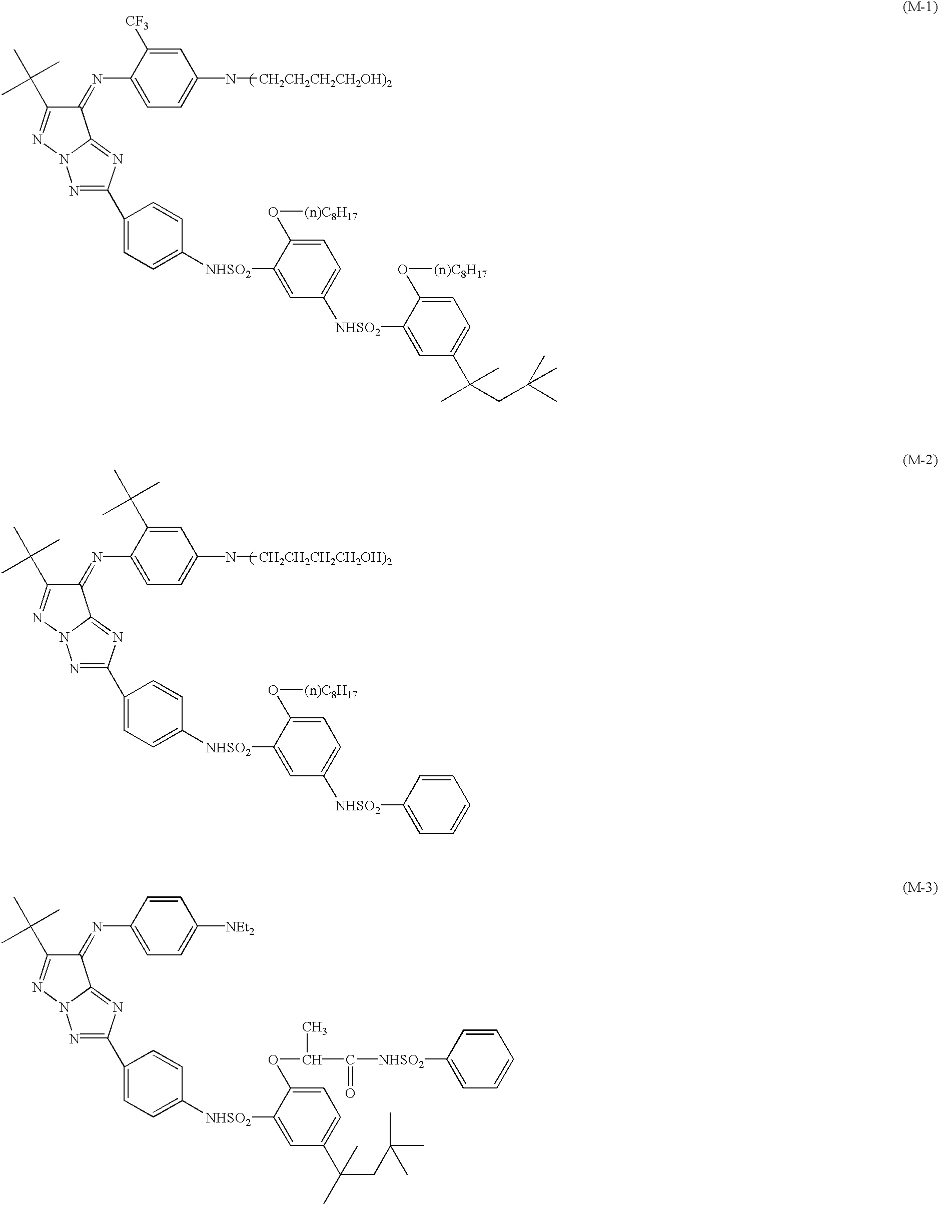

Besides, examples of the compounds used in the invention are described in Japanese Patent Application No. 11-365187, JP-A-2001-181549 and Japanese Patent Application No. 2000-80733, but are not construed to be limited thereto.

The dyes represented by formula (3) of the invention can be synthesized, using methods described in Japanese Patent Application No. 2000-80733 and JP-A-55-161856 as reference.

The dyes represented by formula (4) of the invention can be synthesized, using methods described in JP-A-4-126772 and JP-B-7-94180 as reference.

Of the dyes represented by formula (2), pyrrolotriazole azomethine dyes represented by the following formula (5) are particularly preferably used as the cyan dyes:

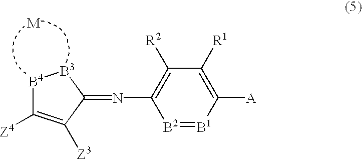

wherein A, R¹, R², B¹ and B² have the same meanings as given for formula (2), and preferred examples thereof are also the same as with formula (2); Z³ and Z⁴ each independently has the same meaning as given for G of formula (4), and may combine with each other to form a ring structure; M is an atomic group which can form a 1,2,4-triazole ring condensed with a5-membered ring of formula (5); and either one of B³and B⁴ of the condensed portion is a nitrogen atom, and the other is a carbon atom.

In the pyrrolotriazole azomethine dyes represented by the above-mentioned formula (5), it is more preferred that Z³ is an electron attractive group having a Hammett substituent σₚ constant of 0.30 or more, because of their sharp absorption. Further, Z³ is more preferably an electron attractive group having a Hammett substituent σₚ constant of 0.45 or more, and most preferably an electron attractive group having a Hammett substituent σₚ constant of 0.60 or more. It is still more preferred that the sum of Hammett substituent σₚ constants of Z³ and Z⁴ is 0.70 or more, because of their excellent hue as a cyan color.

It is better to use as the cyan dyes the pyrrolotriazole azomethine compounds represented by the above-mentioned formula (5). However, they can also be used as the magenta dyes by changing their substituent groups.

Here, the Hammett substituent σₚ constant used in this specification will be illustrated. Hammett's rule is an empirical rule proposed by L. P. Hammett in 1935 for quantitatively discussing the effect of substituent groups on the reaction or equilibrium of benzene derivatives, and today, the validity thereof has been widely accepted. In Hammett's rule, the σₚ constant and the σₘ constant are determined as the substituent constants. These constants can be found in many general publications, and are described in detail, for example, in “Lange's Handbook of Chemistry”, 12th edition, edited by J. A. Dean, (Mc Graw-Hill, 1979) and “Kagaku no Ryoiki”, extra issue, No. 122, pages 96 to 103 (Nankodo, 1979). In this specification, respective substituent groups are limited or illustrated by the Hammett substituent σₚ constant. However, this does not means that the respective substituent groups are limited only to the substituent groups having the constant known in the literature found in the above-mentioned publications. Needless to say, the respective substituent groups also include substituent groups which would be contained in the range thereof when the constant is measured based on Hammett's rule, even if unknown in the literature. Further, although the compounds represented by general formulas (1) to (5) of the invention are not benzene derivatives, the σₚ constant is used as a measure for showing the electronic effect of the substituent groups, independently of the substitution position. The Hammett substituent constant is described in JP-A-2000-181457, and the σₚ constant used in the invention is the same as defined therein.

In the invention, the σₚ constant is hereinafter used in such a sense.

Examples of the electron attractive groups having a Hammett substituent σₚ constant of 0.60 or more include a cyano group, a nitro group, an alkylsulfonyl group (e.g., methanesulfonyl) and an arylsulfonyl group (e.g., benzenesulfonyl)

Examples of the electron attractive groups having a Hammett substituent σₚ constant of 0.45 or more include, in addition to the above, an acyl group (e.g., acetyl), an alkoxylcarbonyl group (e.g., dodecyloxycarbonyl), an aryloxycarbonyl group (e.g., m-chlorophenoxycarbonyl), an alkylsulfinyl group (e.g., n-propylsulfinyl), an arylsulfinyl group (e.g., phenylsulfinyl), a sulfamoyl group (e.g., N-ethylsulfamoyl, N,N-dimethylsulfamoyl) and an alkyl halide group (e.g., trifluoromethyl).

Examples of the electron attractive groups having a Hammett substituent σₚ constant of 0.30 or more include, in addition to the above, an acyloxy group (e.g., acetoxy), a carbamoyl group (e.g., N-ethylcarbamoyl, N,N-dibuthyl-carbamoyl), an alkoxyl halide group (e.g., trifluoromethyloxy), an aryloxy halide group (e.g., pentafluorophenyloxy), a sulfonyloxy group (e.g., methylsulfonyloxy), an alkylthio halide group (e.g., difluoromethylthio), an aryl group substituted by two or more electron attractive groups having a σₚ constant of 0.15 or more (e.g., 2,4-dinitrophenyl, pentachlorophenyl) and a heterocycle (e.g., 2-benzoxazolyl, 2-benzothiazolyl, 1-phenyl-2-benzimidazolyl).

Specific examples of the electron attractive groups having a σₚ constant of 0.20 or more include, in addition to the above, a halogen atom.

Examples of the cyan dyes used in the invention are enumerated below, but they are only illustrative of the invention in detail, and it is to be understood that the invention be not limited thereby.

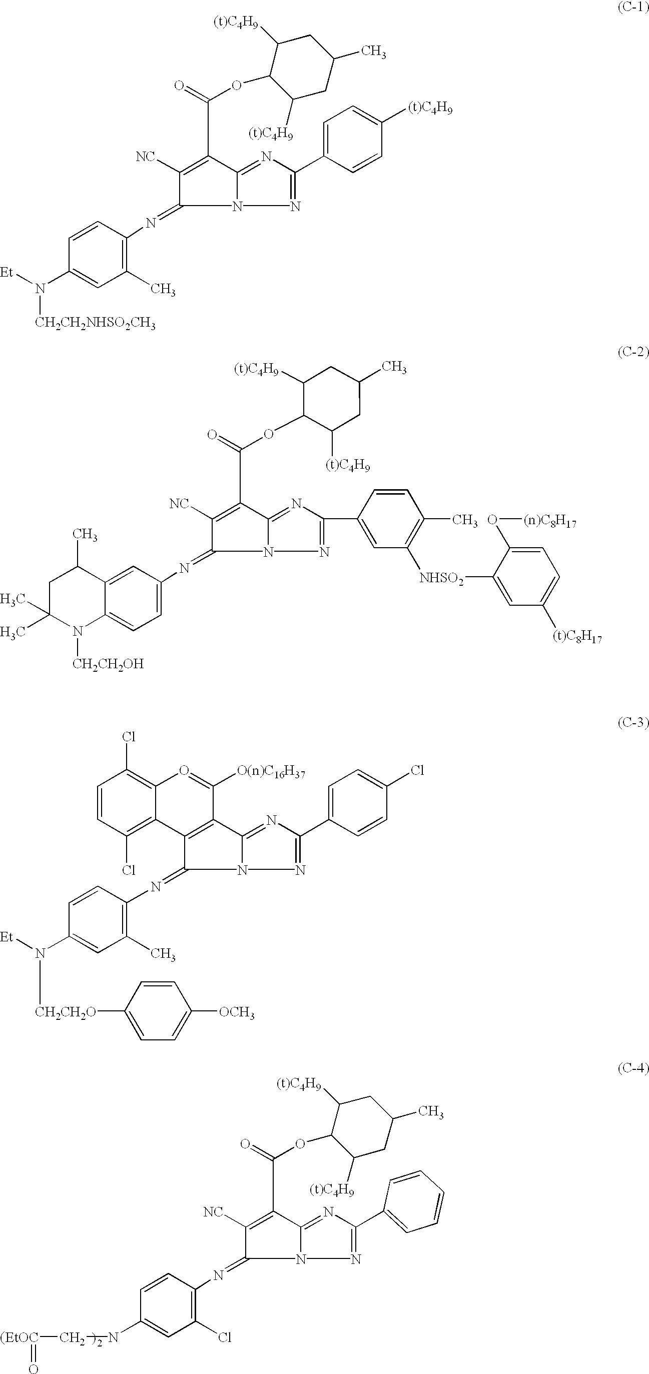

The compounds available in the invention further include example compounds described in JP-A-2001-181457, but are not construed to be limited thereto.

As the pigments used in this technique, there can be utilized known pigments described in various literatures, as well as commercially available pigments. With regard to the literatures, there are “Color Index” (edited by The Society of Dyers and Colourists), “Kaitei Shinpan Ganryo Binran” (Revised Newly-Edited Pigment Handbook) edited by Nippon Ganryo Gijutsu Kyokai (1989), “Saishin Ganryo Oyo Gijutsu” (The Newest Application Techniques of Pigments) published by CMC Shuppan (1986), “Insatsu Ink Gijutsu” (Printing Ink Techniques) published by CMC Shuppan (1984), and W. Herbst and K. Hunger, Industrial Organic Pigments (VCH Verlagsgesellschaft, 1993). Specifically, organic pigments include azo pigments (such as azo lake pigments, insoluble azo pigments, condensed azo pigments and chelate azo pigments), polycyclic pigments (such as phthalocyanine pigments, anthraquinone pigments, perylene and perinone pigments, indigo pigments, quinacridone pigments, dioxazine pigments, isoindolinone pigments, quinophthalone pigments and diketopyrrolopyrrole pigments), dyeing lake pigments (such as lake pigments from acidic or basic dyes) and azine pigments. Inorganic pigments include C.I. Pigment Yellows 34, 37, 42 and 53 of yellow pigments, C.I. Pigment Reds 101 and 108 of red pigments, C.I. Pigment Blues 27, 29 and 17:1 of blue pigments, C.I. Pigment Black 7 and magnetite of black pigments, and C.I. Pigment Whites 4, 6, 18 and 21 of white pigments.

As pigments having hues favorable for image formation, preferred are phthalocyanine pigments, indanthrone pigments of the anthraquinone family (for example, C.I. Pigment Blue 60) and triarylcarbonium pigments of the dyeing lake pigment family, and most preferred are phthalocyanine pigments, in blue or cyan pigments. Preferred examples of the phthalocyanine pigments include copper phthalocyanine pigments such as C.I. Pigment Blues 15:1, 15:2, 15:3, 15:4 and 15:6, monochloro or low-chlorinated copper phthalocyanine pigments, aluminum phthalocyanine pigments as described in European Patent 860475, nonmetallophthalocyanine pigments such as C.I. Pigment Blue 16, and phthalocyanine pigments in which central metals are Zn, Ni or Ti. C.I. Pigment Blues 15:3 and 15:4, and aluminum phthalocyanine pigments are most preferred among others.

In red or purple pigments, there are preferably used azo pigments (preferred examples include C.I. Pigment Reds 3, 5, 11, 22, 38, 48:1, 48:2, 48:3, 48:4, 49:1, 52:1, 53:1, 57:1, 63:2, 144, 146 and 184, and particularly preferred are C.I. Pigment Reds 57:1, 146 and 184), quinacridone pigments (preferred examples include C.I. Pigment Reds 122, 192, 202, 207 and 209 and C.I. Pigment Violets 19 and 42, and particularly preferred is C.I. Pigment Red 122), triarylcarbonium pigments of the dyeing lake pigment family (preferred examples include C.I. Pigment Red 81:1 and C.I. Pigment Violets 1, 2, 3, 27 and 39 of the xanthene family), dioxazine pigments (for example, C.I. Pigment Violets 23 and 37), diketopyrrolopyrrole pigments (for example, C.I. Pigment Red 254), perylene pigments (for example, C.I. Pigment Violet 29), anthraquinone pigments (for example, C.I. Pigment Violets 5:1, 31 and 33) and thioindigo pigments (for example, C.I. Pigment Reds 38 and 88).

As yellow pigments, there are preferably use dazopigments (preferred examples include C.I. Pigment Yellows 1, 3, 74 and 98 of the monoazo pigment family, C.I. Pigment Yellows 12, 13, 14, 16, 17 and 83 of the disazo pigment family, C.I. Pigment Yellows 93, 94, 95, 128 and 155 of the general azo family and C.I. Pigment Yellows 120, 151, 154, 156 and 180 of the benzimidazolone family, and particularly preferred is a pigment using no benzidine compound as a raw material) isoindoline-isoindolinone pigments (preferred examples include C.I. Pigment Yellows 109, 110, 137 and 139), quinophthalone pigments (preferred examples include C.I. Pigment Yellow 138) and flavanthrone pigments (for example, C.I. Pigment Yellow 24).

Black pigments include inorganic pigments (preferred examples include carbon black and magnetite) and aniline black.

Besides, orange pigments (for example, C.I. Pigment Oranges 13 and 16) and green pigments (for example, C.I. Pigment Green 7) may be used.

The pigments available in this technique may be the above-mentioned bare pigments or surface-treated pigments. As a surface treating method, there can be considered a method of coating surfaces of the pigments with a resin or wax, a method of adhering a surfactant to surfaces of the pigments, or a method of bonding a reactive substance (for example, a silane coupling agent, an epoxy compound, or a radical generated from a polyisocyanate or adiazonium salt) to surfaces of thepigments. They are described in the following literatures and patents:

(1) Kinzoku Sekken no Seishitsu to Oyo (Properties and Application of Metal Soap (Saiwai Shobo);

(2) Insatsu Ink Insatsu (Printing Ink Printing) (CMC Shuppan, 1984);

(3) Saishin Ganryo Oyo Gijutsu (The Newest Application Techniques of Pigments) (CMC Shuppan, 1986);

(4) U.S. Pat. Nos. 5,554,739 and 5,571,311; and

(5) JP-A-9-151342, JP-A-10-140065, JP-A-10-292143 and JP-A-11-166145.

In particular, self-dispersing pigments prepared by allowing diazonium salts described in the U.S. patents of the above (4) to act on carbon black, and capsulated pigments prepared by methods described in the Japanese patent of the above (5) are particularly effective, because dispersion stability is obtained without use of excess dispersing agents in ink.

In the invention, the pigments maybe dispersed by further using dispersing agents. As the dispersing agents, there can be used various known dispersing agents, for example, surfactant type low-molecular dispersing agents and polymer type dispersing agents, depending on the pigments used. Examples of the dispersing agents include ones described in JP-A-3-69949 and European Patent 549,486. Further, pigment derivatives called synergists may be added for enhancing absorption of the dispersing agents to the pigments in using the dispersing agents.

The average particle size of the pigment available in this technique is preferably within the range of 0.01 μm to 10 μm after dispersion, more preferably 1 μm or less, and particularly preferably from 0.05 μm to 1 μm.

As methods for dispersing the pigments, there can be used known dispersing techniques used in the production of ink or toner. Dispersing devices include a vertical or horizontal agitator mill, an attriter, a colloid mill, a ball mill, a triple roll mill, a pearl mill, a super mill, an impeller, a disperser, a KD mil, a dynatron and a pressure kneader. Details thereof are described in “Saishin Ganryo Oyo Gijutsu” (The Newest Application Techniques of Pigments) (CMC Shuppan, 1986).

It is preferred that the colorant is contained in an amount of 0.2 part by to 20 parts by weight per 100 parts by weight of water-based ink (ink for ink jet recording) of the invention. Further, in the ink for ink jet recording used in the invention, other dyes may be used in combination with the above-mentioned azo dyes for obtaining full color images or adjusting hues.

In the invention, when the colorants are hydrophobic dyes, the high boiling organic solvents are used in dispersing them in aqueous media by emulsification. In dispersion by emulsification, low boiling organic solvents can be used according to circumstances from the viewpoint of emulsifiability. The low boiling organic solvents are organic solvents having a boiling point of about 30° C. to about 150° C. at atmospheric pressure. Examples of the solvents preferably used include but are not limited to esters (for example, ethyl acetate, butyl acetate, ethyl propionate, β-ethoxyethyl acetate and methyl cellosolve acetate), alcohols (for example, isopropyl alcohol, n-butyl alcohol and sec-butyl alcohol), ketones (for example, methyl isobutyl ketone, methyl ethyl ketone and cyclohexanone), amides (for example, dimethylformamide and N-methylpyrrolidone) and ethers (for example, tetra hydrofuran and dioxane).

Dispersion by emulsification is conducted for dispersing an oily phase dissolved in the high boiling organic solvent or a mixed solvent of the high boiling organic solvent and the low boiling solvent according to circumstances, in an aqueous phase mainly composed of water to prepare minute oil droplets of the oily phase. In this case, an additive such as a surfactant, a wetting agent, a dye stabilizer, an emulsion stabilizer, a preservative or a mildew proofing agent can be added to either of the aqueous phase and the oily phase or both as needed.

As the emulsification method, there is generally used a method of adding the oily phase to the aqueous phase. However, a so-called phase reversal emulsification method can also be preferably used in which the aqueous phase is added dropwise to the oily phase.

The boiling point of the high boiling organic solvents used in the invention is 150° C. or more, and preferably 170° C. or more.

The high boiling organic solvents used in the invention include phthalates (for example, dibutyl phthalate, dioctyl phthalate, dicyclohexylphthalate, di-2-ethylhexylphthalate, decylphthalate, bis (2,4-di-tert-amylphenyl) isophthalate and bis (1,1-diethylpropyl) phthalate), phosphates orphosphonates (for example, diphenyl phosphate, triphenyl phosphate, tricresyl phosphate, 2-ethylhexyldiphenyl phosphate, di-octylbutyl phosphate, tricyclohexyl phosphate, tri-2-ethylhexyl phosphate, tridodecyl phosphate and di-2-ethylhexylphenyl phosphate), benzoates (for example, 2-ethylhexyl benzoate, a 2,4-dichlorobenzoate, dodecyl benzoate and 2-ethylhexyl p-hydroxybenzoate), amides (for example, N,N-diethyldodecaneamide and N,N-diethyllaurylamide), alcohols (for example, isostearyl alcohol), aliphatic esters (for example, dibutoxyethyl succinate, di-2-ethylhexyl succinate, 2-hexyldecyl tetradecanoate, tributyl citrate, diethyl azelate, isostearyl lactate and trioctyl citrate), aniline derivatives (for example, N,N-dibutyl-2-butoxy-5-tert-octylaniline), chlorinated paraffins (for example, paraffins having a chlorine content of 10% to 80%), trimesates (for example, tributyl trimesate), dodecylbenzene, diisopropylnaphthalene, phenols (for example, 2,4-di-tert-amylphenol, 4-dodecyloxyphenol, 4-dodecyloxycarbonylphenol and 4-(4-dodecyloxyphenylsulfonyl)phenol), carboxylic acids (for example, 2-(2,4-di-tert-amylphenoxybutyric acid and 2-ethoxyoctanedecanoic acid), and alkylphosphoric acids (for example, di-(2-ethylhexyl)phosphoric acid and diphenylphosphoric acid). Further, organic solvents having a boiling point of about 30° C. to about 160° C. (for example, ethyl acetate, butyl acetate, ethyl propionate, methyl ethyl ketone, cyclohexanone, 2-ethoxyethyl acetate and dimethylformamide) may be used together as co-solvents. The high boiling organic solvent can be used in a 2-fold or less amount by weight, and preferably in a 1.0-fold or less amount by weight, based on the coupler.

These high boiling organic solvents may be used either alone, or as a mixture of several kinds of them (for example, tricresyl phosphate and dibutyl phthalate, trioctyl phosphate and di(2-ethylhexyl) sebacate, or dibutyl phthalate and poly(N-t-butylacrylamide)).

Compound examples of the high boiling organic solvents other than the above, which are used in the invention, and/or methods for synthesizing these high boiling organic solvents are described, for example, in U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,027,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321 and 5,013,639, EP-A-276,319, EP-A-286,253, EP-A-289,820, EP-A-309,158, EP-A-309,159, EP-A-309,160, EP-A-509,311, EP-A-510,576, East German Patents 147,009, 157,147, 159,573 and 225,240A, British Patent 2,091,124A, JP-A-48-47335, JP-A-50-26530, JP-A-51-25133, JP-A-51-26036, JP-A-51-27921, JP-A-51-27922, JP-A-51-149028, JP-A-52-46816, JP-A-53-1520, JP-A-53-1521, JP-A-53-15127, JP-A-53-146622, JP-A-54-91325, JP-A-54-106228, JP-A-54-118246, JP-A-55-59464, JP-A-56-64333, JP-A-56-81836, JP-A-59-204041, JP-A-61-84641, JP-A-62-118345, JP-A-62-247364, JP-A-63-167357, JP-A-63-214744, JP-A-63-301941, JP-A-64-9452, JP-A-64-9454, JP-A-64-68745, JP-A-1-101543, JP-A-1-102454, JP-A-2-792, JP-A-2-4239, JP-A-2-43541, JP-A-4-29237, JP-A-4-30165, JP-A-4-232946 and JP-A-4-346338.

The above-mentioned high boiling organic solvent is used in a 0.01-fold to 3-fold amount by weight, and preferably in a 0.5-fold to 1-fold amount by weight, based on the dye.

In dispersion by emulsification in the invention, various surfactants can be used. Examples of the surfactants preferably used include anionic surfactants such as fatty acid salts, alkylsulfate ester salts, alkylbenzenesulfonates, alkylnaphthalenesulfonates, dialkylsulfosuccinates, alkylphosphate ester salts, naphthalenesulfonate-formalin condensates and polyoxyethylene alkyl sulfate ester salts, and nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylenealkylamines, glycerol fatty acid esters and oxyethylene-oxypropylene block copolymers. Further, SURFYNOLS (Air Products & Chemicals), an acetylene polyoxyethylene oxide surfactant, is also preferably used. Amine oxide type amphoteric surfactants such as N,N-dimethyl-N-alkylamine oxides are also preferred. Further, surfactants described in JP-A-59-157636, pages 37 and 38, and Research Disclosure, No. 308119 (1989) can also be used.

For stabilizing the dispersions immediately after emulsification, water-soluble polymers can also be added together with the above-mentioned surfactants. As the water-soluble polymers, there are preferably used polyvinyl alcohol, polyvinyl pyrrolidone, polyethylene oxide, polyacrylic acid, polyacrylamide and copolymers thereof. Natural water-soluble polymers such as polysaccharides, casein and gelatin are also preferably used. Further, for stabilizing the dye dispersions, vinyl polymers, polyurethanes, polyesters, polyamides, polyureas and polycarbonates obtained by polymerization of acrylates, methacrylates, vinyl esters, acrylamide, methacrylamide, olefins, styrene derivatives, vinyl ethers and acrylonitrile derivatives, which are substantially insoluble in aqueous media, can also be used together. It is preferred that these polymers contain —SO₂—or —COO—. When these polymers which are substantially insoluble in aqueous media are used together, the polymers are used preferably in an amount of 20% or less by weight, and more preferably in an amount of 10% or less by weight, based on high boiling organic solvent.

When the hydrophobic dyes and the high boiling organic solvents are dispersed by emulsification to prepare water-based ink, particularly important is particle size control thereof. For raising the color purity and the density at the time when images are formed by ink jet recording, it is indispensable to reduce the average particle size. The volume average particle size is preferably 1 μm or less, and more preferably from 5 nm to 200 nm.

It has been revealed that the presence of coarse particles also plays a very major role for printing performance. That is to say, it has been proved that a nozzle of a head is clogged with coarse particles, or coarse particles form stains even if the nozzle is not clogged, which causes a failure to discharge ink or a twist of discharged ink to have a profound influence on printing performance. In order to prevent this, it is important to restrain the number of particles having a size of 5 μm or more to 10 particles or less per μl of ink, and the number of particles having a size of 1 μm or more to 1000 particles or less per μl of ink.

As methods for removing these coarse particles, there can be used known centrifugal separation methods and microfiltration methods. These separating means may be applied immediately after dispersion by emulsification, or after addition of various additives such as a wetting agent and a surfactant to the emulsified dispersion and immediately before charging the dispersion into ink cartridges.

As an effective means for reducing the average particle size and removing coarse particles, there can be used a mechanical emulsifier.

As the emulsifiers, there can be used known apparatus of a simple stirrer or impeller stirring system, an in-line stirring system, a mill system (for example, a colloid mill) and an ultrasonic system. However, the use of a high-pressure homogenizer is particularly preferred.

As to the high-pressure homogenizer, its detailed mechanism is described in U.S. Pat. No. 4,533,254and JP-A-6-47264. Commercially available apparatus include Gaulin Homogenizer (A. P. V. Gaulin Inc.), Microfluidizer (Microfluidex Inc.) and Artimizer (Sugino Machine Co., Ltd.).

Further, a high-pressure homogenizer provided with a mechanism for finely graining particles in an extra-high pressure jet stream as recently described in U.S. Pat. No. 5,720,551 is particularly effective for dispersion by emulsification of the invention. Examples of the emulsifiers using extra-high pressure jet streams include De Bee 2000 (Bee International Ltd.).

When the particles are emulsified with the high-pressure emulsifiers, the pressure is 50 MPa or more, preferably 60 MPa or more, and more preferably 180 MPa or more.

For example, the use of two or more kinds of emulsifiers in combination, such as treatment with a high-pressure homogenizer after emulsification with a stirring emulsifier, is particularly preferred. Further, a method is also preferred in which after the particles are once dispersed by emulsification with the emulsifier, additives such as a wetting agent and a surfactant are added, and then, the emulsified dispersion is allowed to pass through the high-pressure homogenizer again before ink is charged into cartridges.

When the low boiling organic solvents are contained together with the high boiling organic solvents, the low boiling organic solvents are preferably removed from the viewpoints of the stability of the emulsions, and the safety and sanitation. As methods for removing the low boiling organic solvents, various known methods can be used depending on the kind of solvent. That is to say, evaporation methods, vacuum evaporation methods and ultrafiltration methods can be used. It is preferred that the low boiling organic solvents are removed as soon as possible after emulsification.

The water-based ink (ink composition for ink jet recording) used in the invention can be prepared by dissolving and/or dispersing the above-mentioned oil-soluble dye in an aqueous medium.

As to methods for preparing aqueous ink compositions for ink jet recording, details thereof are described in JP-A-5-148436, JP-A-5-295312, JP-A-7-97541, JP-A-7-82515 and JP-A-7-118584. These methods can also be utilized for the preparation of the ink compositions for ink jet recording of the invention.

Examples of the water-soluble organic solvents available in the invention include alcohols (for example, methanol, ethanol, propanol, isopropanol, butanol, isobutanol, sec-butanol, t-butanol, pentanol, hexanol, cyclohexanol and benzyl alcohol), polyhydric alcohols (ethylene glycol, diethylene glycol, triethylene glycol, polyethylene glycol, propylene glycol, dipropylene glycol, polypropylene glycol, butylene glycol, hexanediol, pentanediol, glycerol, hexanetriol and thiodiglycol), glycol derivatives (ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monoethyl ether and ethylene glycol monophenyl ether), amines (for example, ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine and tetramethylpropylenediamine) and other polar solvents (for example, formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1, 3-dimethyl-2-imidazolidinone, acetonitrile and acetone). The above-mentioned water-soluble organic solvents may be used as a combination of two or more of them.

In the water-based ink used in the invention, additives can be appropriately selected and used in proper amounts. Such additives include an anti-drying agent for preventing an ink jet outlet from being clogged due to drying, a penetration accelerator for allowing ink to penetrate paper better, an UV absorber, an antioxidant, a viscosity modifier, a surface tension regulator, a dispersing agent, a dispersion stabilizer, a mildew proofing agent, a corrosion inhibitor, a pH adjusting agent, an antifoaming agent and a chelating agent.

As the anti-drying agents used in the invention, water-soluble organic solvents having a lower vapor pressure than water are preferred. Specific example thereof include polyhydric alcohols represented by ethylene glycol, propylene glycol, diethylene glycol, polyethylene glycol, thiodiglycol, dithiodiglycol, 2-methyl-1,3-propanediol, 1,2,6-hexanetriol, an acetylene glycol derivative, glycerol and trimethylolpropane; lower alkyl ethers of polyhydric alcohols such as ethylene glycol monomethyl (or ethyl) ether, diethylene glycol monomethyl (or ethyl) ether and triethylene glycol monomethyl (or butyl) ether, heterocycles such as 2-pyrrolidone, N-methyl-2-pyrrolidone, 1,3-dimethyl-2-imidazolidinone and N-ethylmorpholine; sulfur-containing compounds such as sulfolane, dimethyl sulfoxide and 3-sulfolene; multifunctional compounds such as diacetone alcohol and diethanolamine; and urea derivatives. Of these, polyhydric alcohols such as glycerol and diethylene glycol are more preferred. The above-mentioned anti-drying agents may be used either alone or as a combination of two or more of them. These anti-drying agents are preferably contained in ink in an amount of 10% to 50% by weight.

The penetration accelerators used in the invention include alcohols such as ethanol, isopropanol, butanol, diethylene glycol monobutyl ether, triethylene glycol monobutyl ether and 1,2-hexanediol, sodium laurylsulfate, sodium oleate and the nonionic surfactants mentioned above as the surfactants for dispersion by emulsification. They shows the sufficient effect when contained in ink in an amount of 10% to 30% by weight, and are preferably added within such a range that no blur of printing and no print through occur.

The UV absorbers used for improving the keeping quality of images in the invention include benzotriazole compounds described in JP-A-58-185677, JP-A-61-190537, JP-A-2-782, JP-A-5-197075 and JP-A-9-34057; benzophenone compounds described in JP-A-46-2784, JP-A-5-194483 and U.S. Pat. No. 3,214,463; cinnamic acid compounds described in JP-B-48-30492, JP-B-56-21141 and JP-A-10-88106; triazine compounds described in JP-A-4-298503, JP-A-8-53427, JP-A-8-239368, JP-A-10-182621 and JP-W-8-501291 (the term “JP-W” as used herein means an unexamined published international patent application); compounds described in Research Disclosure, No. 24239; and compounds represented by stilbene and benzoxazole compounds, which absorb ultraviolet rays to emit fluorescence, so-called fluorescent brightening agents.

As the antioxidants used for improving the keeping quality of images in the invention, there can be used various organic and metal complex antifading agents. The organic antifading agents include hydroquinone and derivatives thereof, alkoxyphenols, dialkoxyphenols, phenols, anilines, amines, indan and derivatives thereof, chroman and derivatives thereof, alkoxyanilines and heterocycles, and the metal complex antifading agents include nickel complexes and zinc complexes. More specifically, there can be used compounds described in patents cited in Research Disclosure, No. 17643, Items VII-I to J, ibid., No.15162, ibid., No.18716, page 650, left column, ibid., No. 36544, page 527, ibid., No. 307105, page 872, and ibid., No. 15162, and compounds contained in general formulas and compound examples of typical compounds described in JP-A-62-21572, pages 127 to 137.

The mildew proofing agents used in the invention include sodium dehydroacetate, sodium benzoate, sodium pyridinethione-1-oxide, ethyl p-hydroxybenzoate, 1,2-benzoiso-thiazoline-3-one and salts thereof. They are preferably used in ink in an amount of 0.02% to 5.00% by weight.

Details of these are described in “Bokin Bobaizai Jiten” (Dictionary of Antibacterial and Mildewproofing Agents) (edited by Editional Committee of Dictionary, Nippon Bokin Bobai Gakkai).

The corrosion inhibitors include, for example, an acid sulfite, sodium thiosulfate, ammonium thioglycolate, diisopropylammonium nitrite, pentaerythritol tetranitrate, dicyclohexylammonium nitrite and benzotriazole. They are preferably used in ink in an amount of 0.02% to 5.00% by weight.

The pH adjusting agents used in the invention can be suitably used in terms of pH adjustment and dispersion stabilization, and are added so as to give preferably a pH of 4.5 to 10.0, and more preferably a pH of 6 to 10.0.

As to the pH adjusting agents, basic ones include organic bases and inorganic alkalis, and acidic ones include organic acids and inorganic acids.

The organic bases include triethanolamine, diethanolamine, N-methyldiethanolamine and dimethylethanolamine. The inorganic alkalis include hydroxides of alkali metals (for example, sodium hydroxide, lithium hydroxide and potassium hydroxide), carbonates (for example, sodium carbonate and sodium hydrogencarbonate) and ammonia.

The organic acids include acetic acid, propionic acid, trifluoroacetic acid and an alkylsulfonic acid. The inorganic acids include hydrochloric acid, sulfuric acid and phosphoric acid.

The surface tension regulators used in the invention include nonionic, cationic and anionic surfactants. The anionic surfactants include, for example, fatty acid salts, alkylsulfate ester salts, alkylbenzenesulfonates, alkylnaphthalenesulfonates, dialkylsulfosuccinates, alkylphosphate ester salts, naphthalenesulfonate-formalin condensates and polyoxyethylene alkyl sulfate ester salts. The nonionic surfactants include polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkylamines, glycerol fatty acid esters and oxyethylene-oxypropylene block copolymers. Surfynols (Air Products & Chemicals), an acetylene polyoxyethylene oxide surfactant, is also preferably used. Amine oxide type amphoteric surfactants such as N,N-dimethyl-N-alkylamine oxides are also preferred. Further, surfactants described in JP-A-59-157636, pages 37 and 38, and Research Disclosure, No. 308119 (1989) can also be used. It is preferred that the surfactants used herein have a solubility in water at 25° C. of 0.5% or more.

The surface tension of the ink of the invention is preferably from 20 mN/m to 60 mN/m, and more preferably from 25 mN/m to 45 mN/m, using or not using these surface tension regulators.

The ink used in the invention preferably has a viscosity of 30 mPa·s or less. It is more preferred that the viscosity is adjusted to 20 mPa·s or less. Accordingly, the viscosity modifier is sometimes used for adjusting the viscosity. The viscosity modifiers include, for example, celluloses, water-soluble polymers such as polyvinyl alcohol, and nonionic surfactants.

In the invention, the above-mentioned various cationic, anionic and nonionic surfactants can also be used as the dispersing agents and dispersion stabilizers, and fluorine and silicone compounds and chelating agents represented by EDTA as the antifoaming agents, as needed.

In forming images by the ink-jet image recording method in the invention, there can be used known materials on which the images are recorded, that is to say, plain paper, resin-coated paper, paper for ink-jet use only described, for example, in JP-A-8-169172, JP-A-8-27693, JP-A-2-276670, JP-A-7-276789, JP-A-9-323475, JP-A-62-238783, JP-A-10-153989, JP-A-10-217473, JP-A-10-235995, JP-A-10-337947, JP-A-10-217597 and JP-A-10-337947, films, paper for both ink-jet and electrophotographic uses, cloths, glass, metal and ceramics.

The recording paper and recording films used for forming images by the ink-jet image recording method in the invention will be described below. Supports used in the recording paper and recording films are composed of chemical pulp such as LBKP or NBKP, mechanical pulp such as GP, PGW, RMP, TMP, CTMP, CMP or CGP, or waste paper pulp such as DIP, and prepared with various machines such as a Fourdrinier paper machine and a cylinder paper machine, adding known additives such as a pigment, a binder, a size agent, a fixing agent, a cationic agent and a paper strong agent as needed. In addition to these supports, either of synthetic paper and plastic film sheets may also be used. The thickness of the supports is desirably from 10 μm to 250 μm, and the basis weight is preferably from 10 g/m² to 250 g/m². The supports may be provided with image receiving layers and back coat layers as such, or after size pressing with starch or polyvinyl alcohol or formation of anchor coat layers. Further, the supports may be subjected to flattening treatment using calendering machines such as a machine calender, a TG calender and a soft calender. In the invention, paper laminated with a polyolefin (e.g., polyethylene, polystyrene, polyethylene terephthalate, polybutene, a copolymer thereof) on both sides, and plastic films are preferably used as the supports. It is preferred that a white pigment (e.g., titanium oxide, zinc oxide) or a coloring dye (e.g., cobalt blue, ultramarine blue, neodymium oxide) is added to the polyolefin.

Pigments and water-soluble binders are contained in the image receiving layers provided on the supports. White pigments are preferred as the pigments, and include white inorganic pigments such as calcium carbonate, kaolin, talc, clay, diatomaceous earth, synthetic amorphous silica, aluminum silicate, magnesium silicate, calcium silicate, aluminum hydroxide, alumina, lithopone, zeolite, barium sulfate, calcium sulfate, titanium dioxide, zinc sulfide and zinc carbonate, and organic pigments such as styrenic pigments, acrylic pigments, urea resins and melamine resins. As the white pigments contained in the image receiving layers, porous inorganic pigments are preferred, and particularly, synthetic amorphous silica having a large pore area is suitable. Although both silicic acid anhydride obtained by the dry process and hydrous silicic acid obtained by the wet process are available as synthetic amorphous silica, the use of hydrous silicic acid is particularly preferred. These pigments may be used as a combination of two or more of them.

The aqueous binders contained in the image receiving layers include water-soluble polymers such as polyvinyl alcohol, silanol-modified polyvinyl alcohol, starch, cationized starch, casein, gelatin, carboxymethyl cellulose, hydroxyethyl cellulose, polyvinyl pyrrolidone, a polyalkylene oxide and a polyalkylene oxide derivative; and water-dispersible polymers such as a styrene-butadiene latex and an acrylic emulsion. These aqueous binders can be used either alone or as a combination of two or more of them. In the invention, of these, polyvinyl alcohol and silanol-modified polyvinyl alcohol are particularly suitable in terms of adhesion to the pigments and separation resistance of the image receiving layers.

The image receiving layers can contain additives such as mordants, water resistance imparting agents, light resistance improvers, surfactants, hardening agents and other additives, as well as the pigments and the aqueous binders.

It is preferred that the mordants to be added to the image receiving layers are immobilized. For that purpose, polymer mordants are preferably used.

The polymer mordants are described in JP-A-48-28325, JP-A-54-74430, JP-A-54-124726, JP-A-55-22766, JP-A-55-142339, JP-A-60-23850, JP-A-60-23851, JP-A-60-23852, JP-A-60-23853, JP-A-60-57836, JP-A-60-60643, JP-A-60-118834, JP-A-60-122940, JP-A-60-122941, JP-A-60-122942, JP-A-60-235134, JP-A-1-161236, U.S. Pat. Nos. 2,484,430, 2,548,564, 3,148,061, 3,309,690, 4,115,124, 4,124,386, 4,193,800, 4,273,853, 4,282,305 and4,450,224. Image receiving materials containing the polymer mordants described in JP-A-1-161236, pages 212 to 215, are particularly preferred. The use of the mordants described therein provides images having excellent image quality, and improves light resistance of images.

The water resistance imparting agents are effective for imparting water resistance to images, and as these water resistance imparting agents, cationic resins are particularly desirable. Such cationic resins include polyamidopolyamine-epichlorohydrin, polyethyleneimine, polyaminesulfone, di-methyldiallylammonium chloride polymer, cationic polyacrylamide and colloidal silica. Of these cationic resins, polyamidopolyamineepichlorohydrin is particularly suitable. The content of these cationic resins is preferably from 1% to 15% by weight, and particularly preferably from 3% to 10% by based on the total solid content of the ink receiving layer.

The light resistance improvers include zinc sulfate, zinc oxide, hindered amine antioxidants, and benzophenone and benzotriazole UV absorbers. Of these, zinc sulfate is particularly preferred.

The surfactants act as coating aids, release improvers, slipperiness improvers or antistatic agents. The surfactants are described in JP-A-62-173463 and JP-A-62-183457.

Organic fluoro compounds may be used instead of the surfactants. The organic fluoro compounds are preferably hydrophobic. Examples of the organic fluoro compounds include fluorine surfactants, oily fluorine compounds (for example, fluorine oil) and solid fluorine compound resins (for example, a tetrafluoroethylene resin). The organic fluoro compounds are described in JP-B-57-9053 (columns 8 to 17), JP-A-61-20994 and JP-A-62-135826.

Other additives added to the image receiving layers include pigment dispersing agents, thickening agents, antifoaming agents, dyes, fluorescent brightening agents, preservatives, pH adjusting agents, matte agents and hardening agents. The image receiving layer may be either of one layer or of two layers.

The recording paper and the recording films can also be provided with back coat layers, and components which can be added to these layers include white pigments, aqueous binders and other components. The white pigments contained in the back coat layers include, for example, white inorganic pigments such as precipitated calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo boehmite, aluminum hydroxide, alumina, lithopone, zeolite, hydrous halloysite, magnesium carbonate and magnesium hydroxide, and organic pigments such as styrene plastic pigments, acrylic plastic pigments, polyethylene microcapsules, urea resins and melamine resins.

The aqueous binders contained in the back coat layers include water-soluble polymers such as a styrene/maleate copolymer, a styrene/acrylate copolymer, polyvinyl alcohol, silanol-modified polyvinyl alcohol, starch, cationized starch, casein, gelatin, carboxymethyl cellulose, hydroxyethyl cellulose and polyvinyl pyrrolidone; and water-dispersible polymers such as a styrene-butadiene latex and an acrylic emulsion.

Other components contained in the back coat layers include antifoaming agents, foam inhibitors, dyes, fluorescent brightening agents, preservatives and water resistance imparting agents.

Fine polymer particle dispersions may be added to the constituent layers (including the back coat layers) of the ink-jet recording paper and the recording films. The fine polymer particle dispersions are used for improving film properties such as dimensional stability, curl prevention, adhesion prevention and crack prevention of films. The fine polymer particle dispersions are described in JP-A-62-245258, JP-A-62-1316648 and JP-A-62-110066. Addition of the fine polymer particle dispersion having a low glass transition temperature (of 40° C. or less) to a mordant-containing layer can prevent cracks and curls of the layer. Further, addition of the fine polymer particle dispersion having a high glass transition temperature can also prevent curls of the layer.

There is no limitation on the ink-jet recording system utilized in the invention, and known systems are used. Such systems include a charge control system of discharging ink utilizing electrostatic attracting force, a drop-on-demand system (pressure pulse system) utilizing vibration pressure of piezoelectric elements, an acoustic ink-jet system of discharging ink by converting electric signals to acoustic beams, irradiating the ink with the beams, and utilizing the resulting radiation pressure, and a thermal ink-jet (bubble jet) system of heating ink to form air bubbles and utilizing the resulting pressure.

The ink-jet recording systems include a system of injecting ink having a low concentration called photo ink as a number of droplets small in volume, a system of using a plurality of ink compositions substantially identical in hue and different in concentration to improve image quality, and a system using colorless and transparent ink.

### EXAMPLES

The invention will be further illustrated with reference to the following examples, which are, however, not to be construed as limiting the invention.

Preparation of Materials to Be Provided with Protective Layers (Images)

(Preparation of Ink Sets 101 to 104)

Deionized water was added to the following components to bring the volume to 1 liter, followed by stirring with heating at 30° C. to 40° C. for 1 hour. Then, the resulting solution was adjusted to pH 9 with 10 mol/l KOH, and filtered through a microfilter having an average pore size of 0.25 μm under reduced pressure to prepare an ink solution for light magenta.

| | | |
|---|---|---|
| Magenta Dye (101) in Specification | 3.75 | g |
| Diethylene Glycol | 150 | g |
| Urea | 37 | g |
| Glycerol | 130 | g |
| Triethylene Glycol Monobutyl Ether | 130 | g |
| SURFYNOL 465 (Air Products & Chemicals) | 10.5 | g |
| Triethanolamine | 6.9 | g |
| Benzotriazole | 0.08 | g |
| PROXEL XL2 | 3.5 | g |

Further, magenta ink, light cyan ink, cyan ink, yellow ink and black ink were prepared by changing the kind of dye, the kinds of additives and the amounts thereof added to prepare ink set 101 shown in Table 1.

TABLE 1
Ink Set 101

| | Light Magenta | Magenta | Light Cyan | Cyan | Yellow | Black |
|---|---|---|---|---|---|---|
| Dye (g/l) | (101) 3.75 | (101) 15.0 | T-2 8.74 | T-2 35.0 | T-3 14.7 | T-5 20.0 |
| | | | | | T-4 14.0 | T-6 20.0 |
| | | | | | | T-7 20.0 |
| | | | | | | T-3 21.0 |
| Diethylene Glycol (g/l) | 150 | 110 | 200 | 130 | 160 | 20 |
| Urea (g/l) | 37 | 46 | — | — | — | — |
| Glycerol (g/l) | 130 | 160 | 150 | 180 | 150 | 120 |
| Triethylene Glycol Monobutyl Ether (g/l) | 130 | 140 | 130 | 140 | 180 | — |
| Diethylene Glycol Monobutyl Ether (g/l) | — | — | — | — | — | 230 |
| 2-Pyrrolidone (g/l) | — | — | — | — | — | 81 |
| SURFYNOL 465 (g/l) | 10.5 | 10.0 | 9.8 | 10.5 | — | — |
| SURFYNOL STG (g/l) | — | — | — | — | 8.5 | 9.8 |
| Triethanolamine (g/l) | 6.9 | 7.0 | 6.0 | 6.3 | 0.9 | 17.9 |
| Benzotriazole (g/l) | 0.08 | 0.07 | 0.08 | 0.08 | 0.06 | 0.06 |
| Proxel XL2 (g/l) | 3.5 | 1.5 | 1.1 | 1.2 | 1.5 | 1.1 |

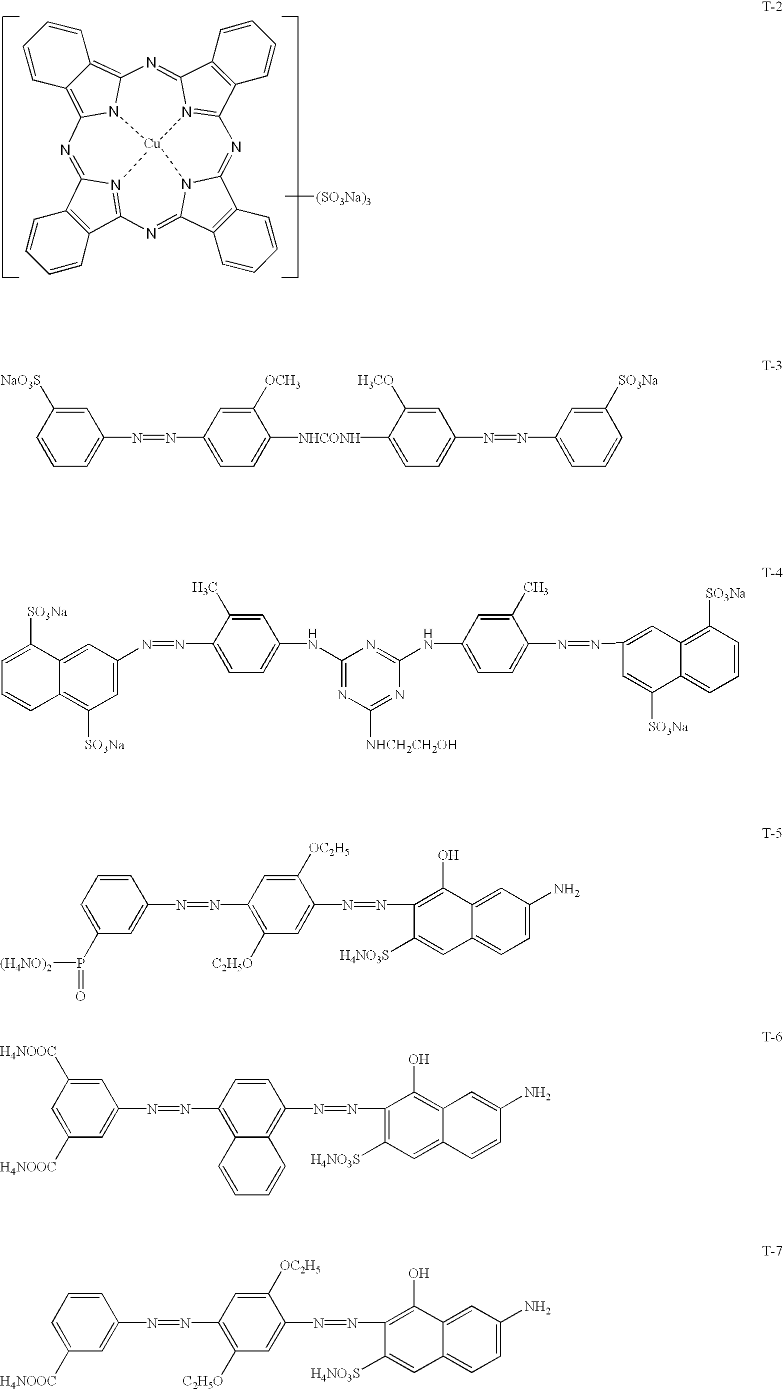

Then, for the light magenta ink and the magenta ink of ink set 101, the kind and amount of dye were changed as shown in Table 2 to prepare ink sets 102 to 104. When dyes were used in combination, the total number of moles of the dyes was adjusted so as to become equivalent to that of ink set 101, and the dyes were used in amounts equimolar with each other.

TABLE 2

| Ink Set | Light Magenta | Magenta |
|---|---|---|
| 102 | Dye MM-1 | Dye MM-1 |
| | 8.8 g/l | 35 g/l |
| 103 | Dye MM-2 | Dye MM-2 |
| | 12.6 g/l | 50.2 g/l |
| 104 | (111)/(114) | (119)/(132) |

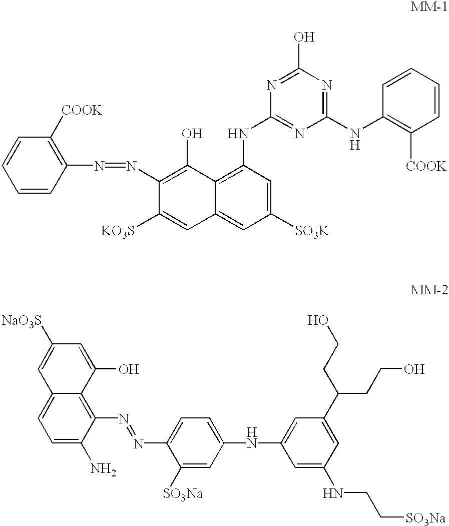

Then, these ink sets 101 to 104 were charged into cartridges of a PM770C ink-jet printer (manufactured by Seiko Epson Corporation), and images were printed on ink-jet paper, photo glossy paper EX, manufactured by Fuji Photo Film Co., Ltd. by use of the same printer.

(Preparation of Ink Sets 101 to 104) Dye (A-1) (8 g) and 40 g of a surfactant (trade name: Emal 20C manufactured by Kao Corp.) were dissolved in 6 g of high boiling organic solvent (S-1), 10 g of high boiling organic solvent (S-2) and 50 ml of ethyl acetate at 7° C. To the resulting solution, 500 ml of deionized water was added while stirring with a magnetic stirrer to prepare an oil-in-water crude particle dispersion.

Then, the crude dispersion was passed 5 times through a Microfluidizer (Microfluidex Inc.) at a pressure of 60 MPa, thereby forming fine particles. Further, for the resulting emulsion, desolvation was performed with a rotary evaporator until the odor of ethyl acetate was removed.

To the fine emulsion of the hydrophobic dye obtained as described above, 140 g of diethylene glycol, 64 g of glycerol and additives such as urea were added, and then, deionized water was added thereto, followed by adjustment to pH 9 with 10 mol/l KOH, thereby preparing light magenta ink according to Table 4. The volume average particle size of the resulting emulsified dispersion ink was measured with a Microtrack UPA (manufactured by Nikkiso Co., Ltd.). As a result, it was 51 nm.

Table 3 shows the composition of the final compositions after the evaporation of the solvents.

Further, changing the kind and amount of dye, the amounts of high boiling organic solvents, and the kinds and amounts of various additives, magenta ink, light cyan ink, cyan ink, yellow ink and black ink of ink set 201 were prepared.

TABLE 3
Ink Set 201

| | Light Magenta | Magenta | Light Cyan | Cyan | Yellow | Black |
|---|---|---|---|---|---|---|
| Dye (g/l) | A-1 5.00 | A-1 20.0 | A-2 9.3 | A-2 37.2 | A-3 27.2 | A-1 10.0 |
| | | | | | | A-2 18.6 |
| | | | | | | A-3 13.6 |
| High Boil- | S-1 | | | | | |
| ing Organic | 3.25 | 14.52 | 6.75 | 27.0 | 19.74 | 30.6 |
| Solvent | S-2 | | | | | |
| (g/l) | 6.25 | 25.52 | 11.9 | 47.6 | 34.7 | 53.8 |
| Emal 20C | 25.0 | 100 | 46.5 | 186.0 | 136.0 | 211.0 |
| (g/l) | | | | | | |
| Diethylene | 87.5 | 87.5 | 87.5 | 87.5 | 87.5 | 87.5 |
| Glycol | | | | | | |
| (g/l) | | | | | | |
| Urea (g/l) | 46.0 | 46.0 | 46.0 | 46.0 | 46.0 | 46.0 |
| Glycerol | 40.0 | 40.0 | 40.0 | 40.0 | 40.0 | 40.0 |
| (g/l) | | | | | | |
| Triethanol- | 7.5 | 7.5 | 7.5 | 7.5 | 7.5 | 7.5 |
| amine (g/l) | | | | | | |
| Benzotri- | 0.075 | 0.075 | 0.075 | 0.075 | 0.075 | 0.075 |
| azole (g/l) | | | | | | |
| Proxel XL2 | 2.5 | 2.5 | 2.5 | 2.5 | 2.5 | 2.5 |
| (g/l) | | | | | | |

Deionized water to make 1 liter

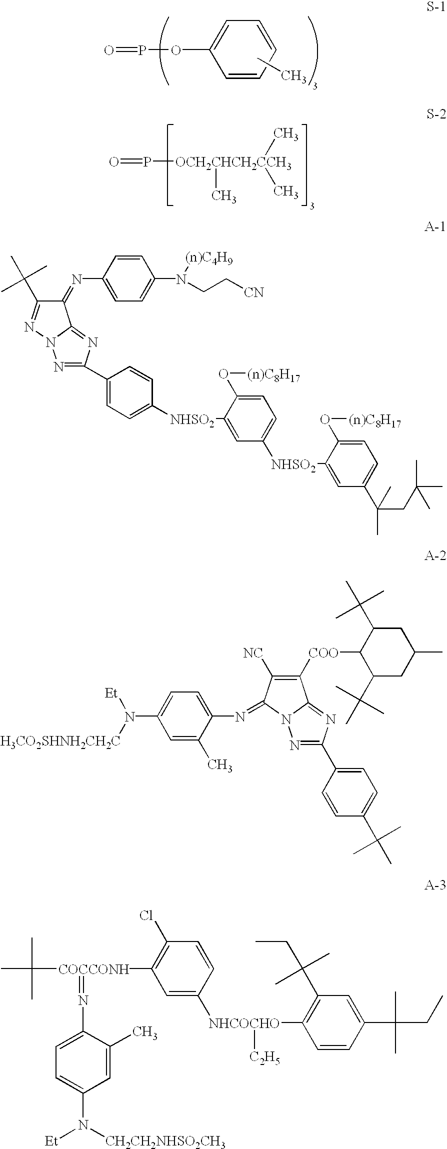

Then, for the light magenta ink and the magenta ink of ink set 201, the kind and amount of dye and the amounts of high boiling organic solvents were changed as shown in Table 4 to prepare ink sets 202 and 203.

TABLE 4

| | | |
|---|---|---|
| Ink Set | Light Magenta | Magenta |

| | | | | |
|---|---|---|---|---|
| 202 | Dye M-22 | 5 g/l | Dye M-22 | 20 g/l |
| | S-1 | 3.25 g/l | | 14.52 g/l |
| | S-2 | 6.25 g/l | | 25.52 g/l |

(In 202, other than light magenta and magenta are the same as with 201)

| Ink | Light | | | | Light | | | | | |
|---|---|---|---|---|---|---|---|---|---|---|
| Set | Magenta | | Magenta | | Cyan | | Cyan | Yellow | | Black |
| 203 | MM-22 | | MM-3 | | CC-2 | | CC-3 | YY-2 | | A-1 |
| | 3.6 | g/l | 17.2 | g/l | 17.4 | g/l | 72.2 g/l | 10.6 | g/l | 10.0 g/l |
| | | | | | | | | YY-3 | | A-2 |
| | | | | | | | | 10.6 | g/l | 18.6 g/l |
| | | | | | | | | | | A-3 |
| | | | | | | 13.6 g/l | | | | |
| | S-1 | | | | | | | | | |
| | 3.25 | g/l | 14.52 | g/l | 6.75 | g/l | 27.0 g/l | 19.74 | g/l | 30.6 g/l |
| | S-2 | | | | | | | | | |
| | 6.25 | g/l | 25.52 | g/l | 11.9 | g/l | 47.6 g/l | 34.7 | g/l | 53.8 g/l |

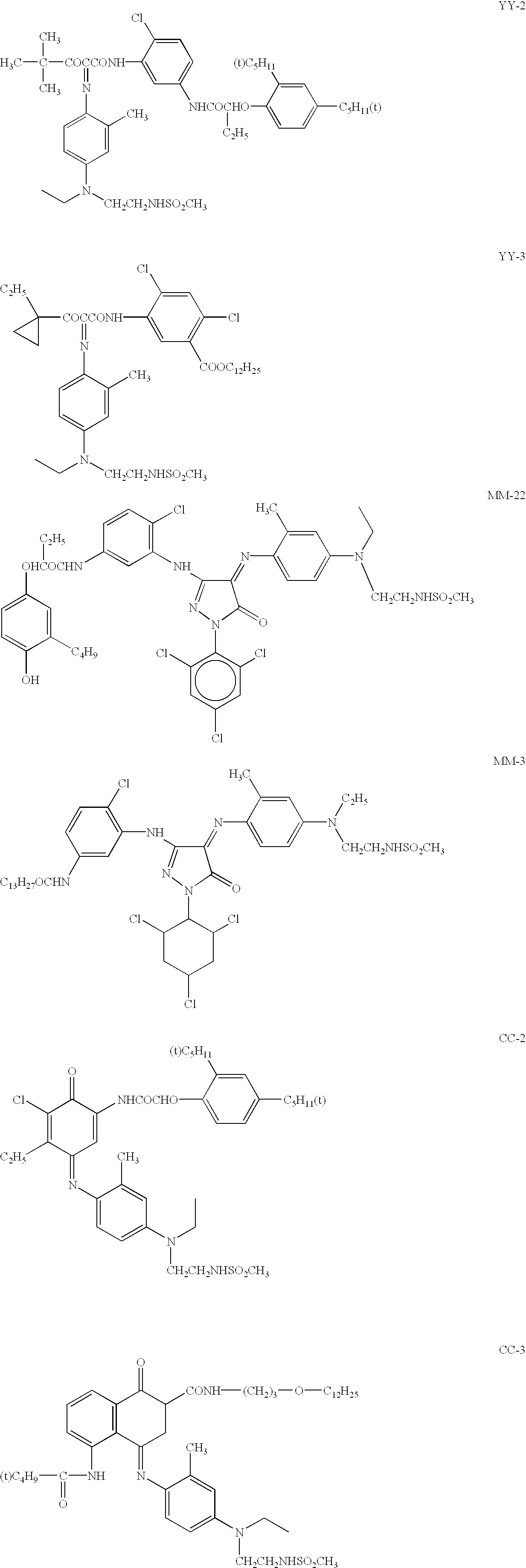

Then, these ink sets 201 to 203 were charged into cartridges of a PM770C ink-jet printer (manufactured by Seiko Epson Corporation), and images were printed on ink-jet paper, photo glossy paper EX, manufactured by Fuji Photo Film Co., Ltd. by use of the same printer.

(Preparation of Ink Sets 301 and 302)

Using ink set 301, an images were printed on ink-jet paper, photo glossy paper EX, manufactured by Fuji Photo Film Co., Ltd. by use of an MC2000 printer (manufactured by Seiko Epson Corporation), a pigment ink-loaded printer. Further, the dyes of ink set 101 were changed to pigments shown in the following Table 5, thereby preparing ink set 302, which was charged into cartridges of a PM770C ink-jet printer (manufactured by Seiko Epson Corporation), and images were printed on ink-jet paper, photo glossy paper EX, manufactured by Fuji Photo Film Co., Ltd. by use of the same printer.

The pigments were dispersed in a sand grinder mill (manufactured by Aimex), using zirconia beads, and B-1 as a dispersing agent in an amount of 40% by weight, based on pigment. The average particle size (diameter) was measured with an electron microscope.

TABLE 5

| Ink Set | Light Magenta | Magenta | Light Cyan | Cyan | Yellow | Black |
|---|---|---|---|---|---|---|
| 302 | C.I. Pigment | C.I. Pigment | C.I. Pigment | C.I. Pigment | C.I. Pigment | Carbon Black |
| | Red 122 | Red 122 | Blue 15.3 | Blue 15.3 | Yellow 74 | 46 g/l |
| | 11.5 g/l | 46 g/l | 10 g/l | 40 g/l | 47 g/l | |
| Average | 25 nm | 28 nm | 30 nm | 30 nm | 29 nm | 32 nm |
| Particle | | | | | | |
| Size | | | | | | |

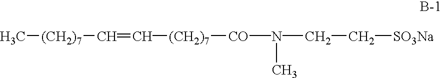

Preparation of Protective Layer-Imparting Materials

A transparent polyethylene terephthalate film having a thickness of 100 μm was coated with a protective layer-imparting coating solution composition having the following composition by the wire coating method so as to give a thickness after drying of 10 μm to prepare each of protective layer-imparting materials P-1 to P-8. Each sample was cut to a size of 100 mm×60 mm.

(Protective Layer-Imparting Coating Solution Composition)

| Binder Resin | x | g |
|---|---|---|
| Radiation-Curing Compound | y1 | g |
| Radiation-Curing Compound | y2 | g |
| Reaction Initiator (Irgacure 651) | 4 | g |
| Matte Agent (Flosen UF-80, Sumitomo Seika | 3.1 | g |
| Chemicals Co., Ltd.) | | |
| Methyl Ethyl Ketone | 240 | ml |

TABLE 6

| | | | | | Radiation-Curing | |
|---|---|---|---|---|---|---|
| Protective | | Amount | Radiation-Curing | Amount | Compound (II) | Amount |
| Layer-Imparting | | Added | Compound (I) | Added | Multifunctional | Added |
| Material | Binder Resin | x (g) | Urethane Acrylate | y1 (g) | Acrylate | y2 (g) |
| P-1 | Acrylic Resin | 53 | Urethane Acrylate | 12.2 | Dipentaerythritol | 3.1 |
| | (Dianal BR87, | | (U2061BA, Shin | | Penta & Hexa- | |
| | Mitsubishi | | Nakamura Kagaku) | | acrylate (A9530, | |
| | Rayon) | | | | Shin Nakamura | |
| | | | | | Kagaku) | |
| | Butyral Resin | 5.5 | | | | |
| | (Esrek BLS, | | | | | |
| | Sekisui | | | | | |
| | Chemical) | | | | | |
| P-2 | Acrylic Resin | 53 | Urethane Acrylate | 12.2 | Trimethylolpro- | 3.1 |
| | (Dianal BR87, | | (U2061BA, Shin | | pane Trimethacry- | |
| | Mitsubishi | | Nakamura Kagaku) | | late (Shin | |
| | Rayon) | | | | Nakamura Kagaku) | |
| | Butyral Resin | 5.5 | | | | |
| | (Esrek BLS, | | | | | |
| | Sekisui | | | | | |
| | Chemical) | | | | | |
| P-3 | Acrylic Resin | 53 | Urethane Acrylate | 12.2 | Pentaerythritol | 3.1 |
| | (Dianal BR87, | | (U2061BA, Shin | | Triacrylate (Shin | |
| | Mitsubishi | | Nakamura Kagaku) | | Nakamura Kagaku) | |
| | Rayon) | | | | | |
| | Butyral Resin | 5.5 | | | | |
| | (Esrek BLS, | | | | | |
| | Sekisui | | | | | |
| | Chemical) | | | | | |
| P-4 | Acrylic Resin | 53 | Urethane Acrylate | 12.2 | Pentaerythritol | 3.1 |
| | (Dianal BR87, | | (U2061BA, Shin | | Tetraacrylate, | |
| | Mitsubishi | | Nakamura Kagaku) | | Shin Nakamura | |
| | Rayon) | | | | Kagaku) | |
| | Butyral Resin | 5.5 | | | | |
| | (Esrek BLS, | | | | | |
| | Sekisui | | | | | |
| | Chemical) | | | | | |
| P-5 | Acrylic Resin | 53 | Urethane Acrylate | 10.7 | Dipentaerythritol | 4.6 |
| | (Dianal BR87, | | (U324A, Shin | | Penta & Hexaacry- | |
| | Mitsubishi | | Nakamura Kagaku) | | late (A9530, Shin | |
| | Rayon) | | | | Nakamura Kagaku) | |
| | Butyral Resin | 5.5 | | | | |
| | (Esrek BLS, | | | | | |
| | Sekisui | | | | | |
| | Chemical) | | | | | |
| P-6 | Acrylic Resin | 53 | Ditto | 10.7 | Trimethylolpro- | 4.6 |
| | (Dianal BR87, | | | | pane Trimethacry- | |
| | Mitsubishi | | | | late (Shin | |
| | Rayon) | | | | Nakamura Kagaku) | |
| | Butyral Resin | 5.5 | | | | |
| | (Esrek BLS, | | | | | |
| | Sekisui | | | | | |
| | Chemical) | | | | | |
| P-7 | Acrylic Resin | 53 | Urethane Acrylate | 10.7 | Pentaerythritol | 4.6 |
| | (Dianal BR87, | | (U324A, Shin | | Triacrylate, Shin | |
| | Mitsubishi | | Nakamura Kagaku) | | Nakamura Kagaku) | |
| | Rayon) | | | | | |
| | Butyral Resin | 5.5 | | | | |
| | (Esrek BLS, | | | | | |
| | Sekisui | | | | | |
| | Chemical) | | | | | |
| P-8 | Acrylic Resin | 53 | Ditto | 10.7 | Pentaerythritol | 4.6 |
| | (Dianal BR87, | | | | Tetraacrylate, | |
| | Mitsubishi | | | | Shin Nakamura | |
| | Rayon) | | | | Kagaku) | |
| | Butyral Resin | 5.5 | | | | |
| | (Esrek BLS, | | | | | |
| | Sekisui | | | | | |
| | Chemical) | | | | | |

For protective layer-imparting materials P-1 to P-8 and materials 101 to 104, 201 to 203, 301 and 302 to be protected with the protective layers, each protective layer was laid on a surface of the material to be protected bypassing them through a laminater at 90° C., 9 kg/cm² and 1 mm/second. Then, the support of the protective layer-imparting material was released, and irradiation was conducted for 5 seconds using a 400-W mercury lamp from a distance of 50 mm. Image-recorded materials thus obtained are shown in Table 7. Of combinations of the above-mentioned protective layer-imparting materials and materials to be protected with the protective layers, experiments were made by changing the order of release of the supports of the protective layer-imparting materials and the UV irradiation. That is to say, for any protective layer-imparting material and any material to be protected, the protective layer was laid on a surface of the material to be protected by passing them through the same laminater, and then, irradiation was conducted for 5 seconds using the same 400-W mercury lamp, followed by release of the support of the protective layer-imparting material. Further, for any protective layer-imparting material and any material to be protected, the protective layer was laid on a surface of the material to be protected by passing them through the laminater, and then, irradiation was conducted for 1 second using the same 400-W mercury lamp, followed by release of the support of the protective layer-imparting material. Then, irradiation was conducted for 4 seconds using the same 400-W mercury lamp.

No protective layers were provided on material 101 to 104, 201 and 301 to prepare image-recorded materials as comparative examples 1 to 6, respectively. Further, the protective layer-imparting coating solution used for the preparation of protective layer-imparting material P-8 was directly applied onto an image of material 101 to prepare an image-recorded material.

The following evaluations were made for the image-recorded materials prepared.

1) Water Resistance

After the resulting image was immersed in deionized water for 30 seconds, a blur of the image was visually evaluated.

2) Image Keeping Quality

Printed samples of yellow, magenta, cyan and black were prepared, and the following evaluations were made.

(1) Light Fastness

The image density Ci immediately after printing was measured with an X-rite 310, and then, the image was irradiated with xenon light (85,000 luxes) by use of a weather meter (manufactured by Atlas Co.) for 14 days. Then, the image density Cf was measured again, and the dye remaining rate (Cf/Ci)×100 was determined to conduct evaluation. The dye remaining rate was evaluated at three reflection intensities of 1, 1.5 and 2. When the dye remaining rate was 7% or more at all intensities, the light fastness was rated as A. When less than 70% at two intensities, the light fastness was rated as B, and when less than 70% at all intensities, the light fastness was rated as C.

(2) Heat Fastness

The image densities before and after storage at 80° C. for 14 days were measured with an X-rite 310 to determine the dye remaining rate, thereby evaluating the heat fastness. The dye remaining rate was evaluated at three reflection intensities of 1, 1.5 and 2. When the dye remaining rate was 90% or more at all intensities, the heat fastness was rated as A. When less than 90% at two intensities, the heat fastness was rated as B, and when less than 90% at all intensities, the heat fastness was rated as C.

(3) Gas Fastness

The image densities before and after storage at an ozone concentration of 0.5 ppm for 14 days were measured with an X-rite 310 to determine the dye remaining rate, thereby evaluating the heat fastness. The dye remaining rate was evaluated at a reflection intensity of 1. When the dye remaining rate was 90% or more, the heat fastness was rated as A. When from more than 60% to less than 90%, the heat fastness was rated as B, and when 60% or less, the heat fastness was rated as C.

3) Difference in Gloss

The difference in a gloss between a printed area and a non-printed area was visually evaluated.

4) Bronze

As to the materials in which the pigments were used, the presence or absence of bronze was visually evaluated.

Results of the evaluations are shown in Table 7.

TABLE 7

| | | | Light | | | Heat | | | Gas | | | | | |
|---|---|---|---|---|---|---|---|---|---|---|---|---|---|---|
| | Protective | Water | Fastness | | | Fastness | | | Fastness | | | Gloss | | |
| Image | Layer | Resistance | Y | M | C | Y | M | C | Y | M | C | Uneveness | Bronze | Note |
| 101 | — | Fair | C | B | B | B | B | B | A | C | C | Good | Good | Comparison 1 |
| 102 | — | Fair | C | C | B | B | B | B | A | C | C | Good | Good | Comparison 2 |
| 103 | — | Fair | C | B | B | B | B | B | A | C | C | Good | Good | Comparison 3 |
| 104 | — | Fair | C | B | B | B | B | B | A | C | C | Good | Good | Comparison 4 |
| 101 | P-1 | Good | B | A | A | A | A | A | A | A | A | Good | Good | Invention |
| 102 | P-1 | Good | B | A | A | A | A | A | A | A | A | Good | Good | Invention |
| 103 | P-1 | Good | B | A | A | A | A | A | A | A | A | Good | Good | Invention |
| 104 | P-1 | Good | B | A | A | A | A | A | A | A | A | Good | Good | Invention |
| 101 | P-2 | Good | B | A | A | A | A | A | A | A | A | Good | Good | Invention |
| 101 | P-3 | Good | B | A | A | A | A | A | A | A | A | Good | Good | Invention |
| 101 | P-4 | Good | B | A | A | A | A | A | A | A | A | Good | Good | Invention |
| 101 | P-5 | Good | B | A | A | A | A | A | A | A | A | Good | Good | Invention |
| 101 | P-6 | Good | B | A | A | A | A | A | A | A | A | Good | Good | Invention |
| 101 | P-7 | Good | B | A | A | A | A | A | A | A | A | Good | Good | Invention |
| 101 | P-8 | Good | B | A | A | A | A | A | A | A | A | Good | Good | Invention |
| 101 | P-8 | Good | B | A | A | A | A | A | A | A | A | Good | Good | Invention |
| 101 | P-8 Coating | Evaluation was impossible because | | | | | | | | | | | | |
| | Solution | of a blur. | | | | | | | | | | | | |
| 201 | — | Good | B | A | A | B | A | A | C | C | C | Good | Good | Comparison 5 |
| 201 | P-2 | Good | A | A | A | A | A | A | A | A | A | Good | Good | Invention |
| 202 | P-3 | Good | A | A | A | A | A | A | A | A | A | Good | Good | Invention |
| 203 | P-4 | Good | A | A | A | A | A | A | A | A | A | Good | Good | Invention |
| 301 | — | Good | A | A | A | A | A | A | A | B | B | Poor | Poor | Comparison 6 |
| 301 | P-2 | Good | A | A | A | A | A | A | A | A | A | Good | Good | Invention |
| 302 | P-3 | Good | A | A | A | A | A | A | A | A | A | Good | Good | Invention |

These results indicate that the samples of the invention are excellent in water resistance, excellent in image keeping quality such as light fastness and heat fastness, have no gloss unevenness, and bring about no bronze even in images recorded using the pigments. The method of forming the protective layer by use of the coating solution is unsuitable because of occurrence of a blur in the ink jet image. In each of the experiments made by changing the order of release of the supports of the protective layer-imparting materials and the UV irradiation, and the experiments in which the supports of the protective layer-imparting materials were released after the UV irradiation, followed by the UV irradiation again, the same results were also obtained.

According to the invention, there can be provided the image-recorded materials which are good in terms of water resistance, light resistance and weather resistance, even thought the protective layers are thin, and can give images having no difference in a gloss between printed areas and non-printed areas, that is to say, no gloss unevenness, and developing little bronze. Further, the production cost can be reduced by making the protective layers thinner, and the image-recorded materials become easily bendable because of no increase in rigidity thereof, which permits the ink jet-recorded images to be handled like paper or photographs.

The entire disclosure of each and every foreign patent application from which the benefit of foreign priority has been claimed in the present application is incorporated herein by reference, as if fully set forth herein.

What is claimed is:

1. A method comprising the steps of:
(a) recording an image on a material by an ink jet recording system using water-based ink comprising a colorant;
(b) laying a protective layer-imparting material comprising a support and a layer comprising a radiation-curing compound that is capable of being a resin at curing, the layer being capable of being released from the protective layer-imparting material, on a surface of the material in such a way that the surface of the material and the layer face each other;
(c) laminating the surface of the material and the protective layer-imparting material by at least one of heating and the application of pressure;
(d) curing the layer by irradiation of a radiation to form a protective layer; and
(e) releasing the support from the protective layer-imparting material.

2. The method of claim 1, wherein the method is carried out by one of three processes of:
1) step (a), step (b), step (c), step (d) and step (e), in order;
2) step (a), step (b), step (c), step (e) and step (d), in order; and
3) step (a), step (b), step (c), step (d), step (e) and step (d), in order.

3. The method of claim 1, which further comprising drying process after recording an image on a material by an ink jet recording system using water-based ink comprising a colorant.

4. The method of claim 1, wherein the colorant is a water-soluble dye.

5. The method of claim 1, wherein the colorant is an oil-soluble dye.

6. The method of claim 5, wherein the water-based ink further comprises a high boiling organic solvent.

7. The method of claim 1, wherein the colorant is a pigment.

8. The method of claim 6, wherein the oil-soluble dye and the high boiling organic solvent are dispersed in the water-based ink in an average particle size of 1 μm or less.

9. The method of claim 7, wherein the pigment is dispersed in the water-based ink in an average particle size of 1 μm or less.

10. The method of claim 1, wherein the water-based ink further comprises a water-soluble organic solvent.

11. The method of claim 1, wherein the material comprises a support and an image receiving layer comprising a white inorganic pigment particle.

12. The method of claim 1, wherein the protective layer has a thickness of from 0.1 μm to 50 μm when the protective layer is dry.

13. An image-recorded material comprising a protective layer prepared by the method of claim 1.
